(19) United States
(12) Patent Application Publication
(10) Pub. No.: US 2026/0333187 A1
(43) Pub. Date: Oct. 22, 2026

(54) METHOD AND APPARATUS FOR PERFORMING DISCOVERY FOR SIDELINK COMMUNICATION IN WIRELESS COMMUNICATION SYSTEM

(71) Applicant: Samsung Electronics Co., Ltd., Gyeonggi-do (KR)

(72) Inventors: Jeongseok YU, Gyeonggi-do (KR); Anil AGIWAL, Gyeonggi-do (KR); Hyunjeong KANG, Gyeonggi-do (KR)

(21) Appl. No.: 19/689,224

(22) Filed: May 27, 2026

Related U.S. Application Data
(63) Continuation of application No. 18/474,800, filed on Sep. 26, 2023.

(30) Foreign Application Priority Data
Sep. 27, 2022 (KR) 10-2022-0122566

(51) Int. Cl. H04W 40/22; H04W 8/00; H04W 88/04

(52) U.S. Cl. CPC H04W 40/22; H04W 8/005; H04W 88/04

(57) ABSTRACT

The disclosure relates to a fifth generation (5G) or sixth generation (6G) communication system to support a data transmission rate higher than before. Disclosed is a method performed by a first user equipment (UE), including obtaining configuration information including information on a threshold used for identifying, by the first UE performing a UE-to-UE (U2U) relay operation, whether to perform transmission of a second message based on a first message received by the first UE from a second UE, receiving, from the second UE, a first discovery message including information on the second UE, identifying, based on reference signal received power (RSRP) measured based on communication with the second UE and the threshold, whether to perform transmission of the second message based on the received first discovery message, and performing, based on a result of the identification, transmission of the second message based on the received first discovery message.

### CROSS-REFERENCE TO RELATED APPLICATIONS

This application is a Continuation Application of U.S. Patent Application No. 18/474,800, filed Sep. 26, 2023, and is based on and claims priority under 35 U.S.C. §119 to Korean Patent Application No. 10-2022-0122566, which was filed in the Korean Intellectual Property Office on Sep. 27, 2022, the disclosure of each of which is incorporated herein by reference in their entireties.

### BACKGROUND

### 1. Field

The disclosure relates generally to a wireless communication system, and more particularly, to a method and apparatus for transmitting a discovery message for an inter-user equipment (UE) relay for sidelink communication of a wireless communication system.

### 2. Description of Related Art

Fifth generation (5G) mobile communication technology defines a wide frequency band to enable fast transmission speeds and new services, including sub-6 gigahertz (Sub 6GHz) bands such as 3.5 GHz, as well as millimeter wave (mmwave) bands such as 28 GHz and 39 GHz. This may be implemented in the ultra-high frequency band (above 6GHz) referred to as Wave. In the sixth generation (6G) mobile communication technology, also referred to as beyond 5G, Terra is working to achieve a transmission speed that is 50 times faster than 5G mobile communication technology and an ultra-low delay time that is reduced to one-tenth. Implementation in terahertz (THz) bands (e.g., 3 terahertz bands at 95 GHz) is being considered.

Early in the 5G mobile communication technology development, there were concerns about ultra-wideband services such as enhanced mobile broadband (eMBB), ultra-reliable low-latency communications (URLLC), and massive machine-type communications (mMTC). With the goal of satisfying service support and performance requirements, efficient use of ultra-high frequency resources, including beamforming and massive array multiple input/output (massive MIMO) to alleviate radio wave path loss in ultra-high frequency bands and increase radio transmission distance. Various numerology support (multiple subcarrier interval operation, etc.) and dynamic operation of slot format, initial access technology to support multi-beam transmission and broadband, definition and operation of band-width part (BWP), large capacity New channel coding methods such as low density parity check (LDPC) codes for data transmission and polar code for highly reliable transmission of control information, L2 pre-processing, and dedicated services specialized for specific services. Standardization of network slicing, etc., which provides networks, has been performed.

Currently, there are ongoing discussions regarding improvement and performance enhancement of initial 5G mobile communication technologies in view of services to be supported by 5G mobile communication technologies, based on the vehicle's own location and status information. Vehicle-to-everything (V2X) for aiding driving determination by autonomous vehicles based on information regarding positions and states of vehicles transmitted by the vehicles and for enhancing user convenience, and new radio unlicensed (NR-U), which aims to operate a system that meets various regulatory requirements in unlicensed bands. ), NR terminal low power consumption technology (UE power saving), non-terrestrial network (NTN), which is direct terminal-satellite communication to secure coverage in areas where communication with the terrestrial network is impossible, positioning, and physical layer standardization for technology are also being developed.

In addition, integrated access and backhaul (IAB) provides a node for expanding the network service area by integrating intelligent factories such as the industrial Internet of things (IIoT) to support new services through linkage and convergence with other industries, and wireless backhaul links and access links. IAB, mobility enhancement including conditional handover and dual active protocol stack (DAPS) handover, and 2-step random access channel (2-step RACH) for simplification of random access procedures) standardization in the field of wireless interface architecture/protocol for technologies such as NR) are also in progress, along with a 5G baseline for incorporating network functions virtualization (NFV) and software-defined networking (SDN) technology standardization in the field of system architecture/services for architecture (e.g., service based architecture, service based interface) and mobile edge computing (MEC), which provides services based on the location of the terminal.

When this 5G mobile communication system is commercialized, an large increase in connected devices to the communication network will ensue. Accordingly, it is expected that strengthening the functions and performance of the 5G mobile communication system and integrated operation of connected devices will be necessary. To this end, extended reality (XR) and Artificial Intelligence are designed to efficiently support augmented reality (AR), virtual reality (VR), and mixed reality (MR). , AI) and machine learning (ML), new research will be conducted on 5G performance improvement and complexity reduction, AI service support, metaverse service support, and drone communication.

The development of such a 5G mobile communication system is a new waveform, full dimensional MIMO (FD-MIMO), and array antenna for guaranteeing coverage in the terahertz band of 6G mobile communication technology. Multi-antenna transmission technologies, such as large scale antennas, metamaterial-based lenses and antennas to improve coverage of terahertz band signals, high-dimensional spatial multiplexing technology using orbital angular momentum (OAM), reconfigurable intelligent surface (RIS) technology, as well as full duplex technology to improve frequency efficiency and system network of 6G mobile communication technology, satellite, and artificial intelligence (AI) are utilized from the design stage and end-to-end (end-to-end)-to-end) development of AI-based communication technology that realizes system optimization by internalizing AI-supported functions and next-generation distributed computing technology that realizes complex services beyond the limits of terminal computing capabilities by utilizing ultra-high-performance communication and computing resources could be realized.

Wireless communication systems have diverged from providing early voice-oriented services to high speed packet access (HSPA), long term evolution (LTE) or evolved universal terrestrial radio access (E-UTRA), and LTE-advanced. Broadband wireless that provides high-speed, high-quality packet data services such as communication standards such as (LTE-A), LTE-Pro, high rate packet data (HRPD), and ultra mobile broadband (UMBB).

As an example of a broadband wireless communication system, the LTE system uses orthogonal frequency division multiplexing (OFDM) in the downlink (DL), and single carrier frequency division multiple access (SC-FDMA) in the uplink (UL)., which refers to a wireless link through which a terminal (or UE) transmits data or control signals to a base station (eNB or gNB). The DL refers to a wireless link through which a base station transmits data or control signals to the terminal. The multiple access method described above differentiates each user's data or control information by allocating and operating the time-frequency resources to carry data or control information for each user so that they do not overlap and orthogonality is established.

As a future communication system after LTE, the 5G communication system must be able to freely reflect the various requirements of users and service providers, so services that simultaneously satisfy various requirements must be supported. Services considered for 5G communication systems include eMBB, mMTC, and URLLC.

The eMBB aims to provide more improved data transmission rates than those supported by existing LTE, LTE-A, or LTE-Pro. For example, in a 5G communication system, eMBB must be able to provide a peak data rate of 20Gbps in the DL and 10Gbps in the UL from the perspective of one base station. In addition, the 5G communication system may need to provide the maximum transmission rate and at the same time provide an increased user perceived data rate. In order to meet these requirements, the 5G communication system may require improvements in various transmission and reception technologies, including more advanced MIMO transmission technology. In addition, while the current LTE transmits signals using a maximum of 20 MHz transmission bandwidth in the 2 GHz band, the 5G communication system uses a frequency bandwidth wider than 20 MHz in the 3 to 6 GHz or above 6 GHz frequency band, meeting the requirements of the 5G communication system. Data transfer speed can be satisfied.

At the same time, mMTC is being considered to support application services such as the Internet of things (IoT) in 5G communication systems. In order to efficiently provide the IoT, mMTC may require support for access to a large number of terminals within a cell, improved coverage of terminals, improved battery time, and reduced terminal costs. Since the IoT provides communication functions by attaching various sensors and various devices, it must be able to support a large number of terminals (for example, 1,000,000 terminals/km^2) within a cell. Additionally, due to the nature of the service, terminals supporting mMTC are likely to be located in shadow areas that cannot be covered by cells, such as the basement of a building, so wider coverage may be required compared to other services provided by the 5G communication system. Terminals that support mMTC must be composed of low-cost terminals, and since it is difficult to frequently replace the terminal's battery, a very long battery life time, such as 10 to 15 years, may be required.

The URLLC is a cellular-based wireless communication service used for specific purposes (mission-critical), such as remote control of robots or machinery, industrial automation, and may be used for services such as unmanned aerial vehicles, remote health care, and emergency alerts. Therefore, the communication provided by URLLC needs to provide (ultra-low latency and ultra-reliability. For example, a service that supports URLLC must meet an air interface latency of less than 0.5 milliseconds and may have a packet error rate of less than 10^-5. . Therefore, for services that support URLLC, the 5G system must provide a smaller transmission time interval (TTI) than other services, and a design that requires allocating wide resources in the frequency band to ensure the reliability of the communication link.

The eMBB, URLLC, and mMTC, can be multiplexed and transmitted in one system. Different transmission/reception techniques and transmission/reception parameters can be used between services to satisfy the different requirements of each service. However, the above-described mMTC, URLLC, and eMBB are only examples of different service types, and the service types to which this disclosure is applied are not limited to the above-described examples.

A transmission UE herein refers to a UE that transmits sidelink data and control information or a UE that receives sidelink feedback information. A reception UE herein refers to a UE that receives sidelink data and control information or a UE that transmits sidelink feedback information.

Various attempts to apply a 5G communication system to the IoT network have been made. For example, technologies such as a sensor network, machine to machine (M2M), and machine type communication (MTC), have been implemented by the 5G communication technology such as beamforming, MIMO, an array antenna scheme, and the like. To apply a cloud radio access network (RAN) as a big data processing technology is an example of technological convergence between 5G and IoT. As described above, a plurality of services may be provided to a user in a communication system. To do so, there is a need in the art for a method and an apparatus for providing services according to respective characteristics within the same time interval. Research on various services provided in the 5G communication system has been conducted, including a service that satisfies requirements of low latency and high reliability.

In the case of vehicle communication, an LTE-based V2Xsystem has been standardized based on a device-to-device (D2D) communication structure in 3GPP releases14 and 15 (Rel-14 and Rel-15). Currently, an effort to develop a V2X system based on 5G new radio (NR) is being made. The NR V2X system is expected to support unicast communication, groupcast (or multicast) communication, and broadcast communication between UEs. Unlike an LTE V2X which is for transmission or reception of basic safety information needed when a vehicle drives on a road, the NR V2X is to provide an advanced service such as platooning, advanced driving, an extended sensor, or remote driving.

In the sidelink of a V2X, whether to perform channel access by a UE and a range of configuration of a transmission parameter may be identified depending on whether a corresponding channel is busy. This is a congestion control function in which the UE controls channel access by dropping transmission or adjusting schedule in case that the channel is busy, or the UE selects a transmission parameter appropriate for the congestion condition of the channel in case that the UE accesses the channel so as to increase a success rate of transmission. The UE may measure a channel busy ratio (CBR) and, based thereon, may select a parameter for transmission. The CBR is an index indicating the degree of channel occupancy by UEs in association with a current channel, and the range of a transmission parameter selectable based on a CBR value may be identified. In addition to measuring a CBR, the UE may measure a channel occupancy ratio (CR), so as to perform congestion control. The CR is an index indicating the degree of channel occupancy by a UE, and a CR limit by which a UE is capable of occupying a channel may be identified based on a CBR value. For example, in case a channel is busy (in case that a measured CBR is high), a CR limit is configured to be low and thus, the UE may perform congestion control so that a measured CR does not exceed the CR limit. The UE needs to satisfy the CR limit by dropping transmission or performing scheduling.

In an NR sidelink, hybrid automatic repeat and request (HARQ) acknowledgement (ACK)/negative acknowledgement (NACK) feedback and channel state information (CSI) feedback are considered and thus, in addition to the operation of a transmission UE, the operation of a reception UE in association with feedback to transmission may also be considered when compared to the case of an LTE sidelink. Therefore, an operation in which a transmission UE and a reception UE exchange CBR information may be considered. In the NR sidelink, a HARQ feedback-based retransmission method that performs retransmission based on HARQ ACK/NACK feedback may be supported as a retransmission method, as well as a blind-based retransmission method that performs retransmission without using HARQ feedback information. When a UE measures a CR, channel occupancy and channel usage allowed in the future may also be applied, as well as records of channel occupancy and channel usage in the past from the current point in time. In the case of the HARQ ACK/NACK feedback-based retransmission method, although a resource is reserved (reservation) so that a transmission UE is capable of occupying and using the resource, the resource occupied for retransmission may be cancelled since retransmission may not be performed in case ACK is reported from a reception UE, which needs to be considered when a CR is measured.

Thus, there is a need in the art for a method and apparatus to perform congestion control when a vehicle UE that supports a V2X performs information transmission or reception with another vehicle UE and a pedestrian’s portable UE via a sidelink.

### SUMMARY

The disclosure has been made to address at least the above-mentioned problems and/or disadvantages and to provide at least the advantages described below.

Accordingly, an aspect of the disclosure is to provide a service using an inter- UE relay by providing a method and apparatus for transmitting a discovery message for an inter-UE relay for sidelink communication of a wireless communication system.

Another aspect of the disclosure is to provide a method and apparatus to perform congestion control when a vehicle UE that supports a V2X performs information transmission or reception with another vehicle UE and a pedestrian’s portable UE via a sidelink.

Another aspect of the disclosure is to provide a method and apparatus in which a transmission UE may measure a CBR and a CR so as to identify whether a channel is busy and, based on a result of the identification, may identify whether to perform channel access by a UE and the range of configuration of a transmission parameter.

Another aspect of the disclosure is to provide a UE that may effectively configure an inter-UE relay by receiving a discovery transmitted from another UE or inter-foreign UE message and identifying an object for relay or an object for response.

In accordance with an aspect of the disclosure, there is provided a method performed by a first UE in a wireless communication system, including obtaining configuration information including information on a threshold used for identifying, by the first UE performing a UE-to-UE (U2U) relay operation, whether to perform transmission of a second message based on a first message received by the first UE from a second UE, receiving, from the second UE, a first discovery message including information on the second UE, identifying, based on reference signal received power (RSRP) measured based on communication with the second UE and the threshold, whether to perform transmission of the second message based on the received first discovery message, and performing, based on a result of the identification, transmission of the second message based on the received first discovery message.

In accordance with an aspect of the disclosure, there is provided a method performed by a UE in a wireless communication system, including obtaining configuration information including information on a threshold used for identifying a candidate relay UE associated with a U2U relay operation or identifying whether to perform transmission of a discovery response message in response to a received discovery message, receiving, from the first UE, a first discovery message, and in case that an RSRP measured based on communication with the first UE is above the threshold, identifying the first UE as the candidate relay UE or performing transmission of a discovery response message in response to the received first discovery message.

In accordance with an aspect of the disclosure, a first UE in a wireless communication system includes a transceiver, and a controller coupled with the transceiver and configured to obtain configuration information including information on a threshold used for identifying, by the first UE performing a U2U relay operation, whether to perform transmission of a second message based on a first message received by the first UE from a second UE, receive, from the second UE, a first discovery message including information on the second UE, identify, based on an RSRP measured based on communication with the second UE and the threshold, whether to perform transmission of the second message based on the received first discovery message, and perform, based on a result of the identification, transmission of the second message based on the received first discovery message.

In accordance with an aspect of the disclosure, a second UE in a wireless communication system includes a transceiver, and a controller coupled with the transceiver and configured to obtain configuration information including information on a threshold used for identifying a candidate relay UE associated with a U2U relay operation or identifying whether to perform transmission of a discovery response message in response to a received discovery message, receive, from the first UE, a first discovery message UE, and in case that an RSRP measured based on communication with the first UE is above the threshold, identify the first UE as the candidate relay or perform transmission of a discovery response message in response to the received first discovery message.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A illustrates a scenario associated with sidelink communication in a wireless communication system according to an embodiment;

FIG. 1B illustrates a scenario associated with sidelink communication in a wireless communication system according to an embodiment;

FIG. 1C illustrates a scenario associated with sidelink communication in a wireless communication system according to an embodiment;

FIG. 1D illustrates a scenario associated with sidelink communication in a wireless communication system according to an embodiment;

FIG. 2A illustrates a transmission scheme of sidelink communication in a wireless communication system according to an embodiment;

FIG. 2B illustrates a transmission scheme of sidelink communication in a wireless communication system according to an embodiment;

FIG. 3 illustrates a sidelink resource pool in a wireless communication system according to an embodiment;

FIG. 4 illustrates a signal flow for allocating a transmission resource of a sidelink in a wireless communication system according to an embodiment;

FIG. 5 illustrates a signal flow for allocating a transmission resource of a sidelink in a wireless communication system according to an embodiment;

FIG. 6 illustrates a structure of a channel of a slot used for sidelink communication in a wireless communication system according to an embodiment;

FIG. 7 illustrates a configuration of a UE-to-network (U2N) relay according to an embodiment;

FIG. 8 illustrates a configuration of a UE-to-UE (U2U) relay according to an embodiment;

FIG. 9 illustrates a discovery procedure using a discovery message in a U2U relay according to an embodiment;

FIG. 10A illustrates a transmission of a discovery message in a U2U relay according to an embodiment;

FIG. 10B illustrates a transmission of a discovery message in a U2U relay according to an embodiment;

FIG. 11 illustrates an example in which a U2U source UE configures a PC5 unicast link with a U2U destination UE via a U2U relay UE by using a direct communication request message in a U2U relay according to an embodiment;

FIG. 12 illustrates a transmission of a direct communication request (DCR) message by a U2U relay UE in a U2U relay according to an embodiment;

FIG. 13 illustrates a structure of a base station according to an embodiment; and

FIG. 14 illustrates a structure of a user equipment (UE) according to an embodiment.

### DETAILED DESCRIPTION

Hereinafter, embodiments of the present disclosure will be described in detail with reference to the attached drawings. Descriptions of well-known functions and constructions may be omitted for the sake of clarity and conciseness.

In the accompanying drawings, some components are exaggerated, omitted, or schematically illustrated. In addition, the size of each component does not entirely reflect the actual size. In each figure, the same reference number is given to the same or corresponding component.

Advantages and features of the disclosure, and methods for achieving them, will become clear with reference to embodiments described below in conjunction with the accompanying drawings. However, the disclosure is not limited to the embodiments disclosed below and may be implemented in various different forms, only the embodiments make the disclosure of the disclosure complete, and the common knowledge in the art to which the disclosure pertains Like reference numbers designate like elements throughout the disclosure. If it is determined that a detailed description of a related function or configuration may unnecessarily obscure the subject matter of the disclosure, the detailed description will be omitted. In addition, terms to be described later are terms defined based on functions in the disclosure, which may vary according to intentions or customs of users or operators. Therefore, the definition should be made based on the contents throughout this disclosure.

Herein, new radio (NR), a radio access network on the 5G mobile communication standard specified by the 3^{rd} generation partnership project (3GPP), a mobile communication standardization organization, and the packet core 5G System, or 5G core network, or next generation core (NG Core) is are described, but the disclosure is applied with slight modifications to other communication systems having similar technical backgrounds without significantly departing from the scope of the disclosure.

Hereinafter, for convenience of description, some terms and names defined in the 3GPP standards (5G, NR, long term evolution (LTE), or similar system standards) may be used. However, the disclosure is not limited by terms and names, and may be equally applied to systems conforming to other standards.

Terms for identifying access nodes used in the description, terms for network entities (network entities), terms for messages, terms for interfaces between network entities, and various types of identification information. Terms and the like referring to are illustrated for convenience of description. Therefore, the disclosure is not limited to the terms used herein, and other terms that refer to objects having equivalent technical meanings may be used.

A base station is a subject that performs resource allocation of a terminal, and may be at least one of a gNode B, an eNode B, a Node B, a base station (BS), a wireless access unit, a base station controller, or a node on a network. The terminal may include a user equipment (UE), a mobile station (MS), a cellular phone, a smart phone, a computer, or a multimedia system capable of performing communication functions. Herein, the DL is a radio transmission path of a signal transmitted from a base station to a terminal, and the UL refers to a radio transmission path of a signal transmitted from a terminal to a base station.

The term 'unit' used herein indicates software or a hardware component, such as a field programmable gate array (FPGA) or application specific integrated circuit (ASIC), and performs certain roles.. However, '~ part' is not limited to software or hardware and may be configured to be in an addressable storage medium and may be configured to reproduce one or more processors. Therefore, as an example, '~unit' refers to components, such as software components, object-oriented software components, class components, and task components, processes, functions, properties, and procedures, subroutines, segments of program code, drivers, firmware, microcode, circuitry, data, databases, data structures, tables, arrays, and variables. Functions provided within components and '~units' may be combined into smaller numbers of components and '~units' or further separated into additional components and '~units'. In addition, the components and '~units' may be implemented to reproduce one or more central processing units (CPUs) in a device or a secure multimedia card. In addition, a '~ unit' may include one or more processors.

The disclosure provided below relates to a method and apparatus for transmitting a discovery message for an inter-UE relay. Specifically, in case that a UE that supports an inter-UE relay receives a discovery message transmitted from another UE that supports an inter-UE relay or receives an inter-foreign UE message, the UE may or may not perform, based on a wireless channel measurement result obtained using the received discovery message or the inter-foreign UE message, transmission of inter-UE relay information, the discovery message for providing a serving capable of using an inter-UE relay, or the inter-UE message.

Terms that refer to signals, channels, control information, network entities, component elements of an apparatus, and the like are provided for ease of description. Accordingly, the disclosure is not limited to the following terms and other terms having the same technical meaning may be used.

A physical channel and signal herein may be interchangeably used with data or a control signal. For example, although a physical DL shared channel (PDSCH) refers to a physical channel via which data is transmitted, the PDSCH may also refer to data. That is, in the disclosure, the expression 'transmit a physical channel' may be interpreted equivalently to the expression 'transmit data or a signal via a physical channel'.

Herein, higher signaling is a method of transferring a signal by a base station to a UE using a DL data channel in a physical layer, or a method of transferring a signal by a UE to a base station using a UL data channel in the physical layer. Higher signaling may be understood as radio resource control (RRC) signaling or a media access control (MAC) control element (CE).

In the disclosure, the expression, 'greater than' or 'less than', is used in order to identify whether a predetermined condition is satisfied or fulfilled. However, the expression is merely used to express an example and does not exclude the expression, 'greater than or equal to' or 'less than or equal to'. A condition including the expression 'greater than or equal to' may be replaced with a condition including the expression 'greater than', a condition including the expression 'less than or equal to' may be replaced with a condition including the expression 'less than', and a condition including the expression 'greater than or equal to and less than' may be replaced with a condition including the expression 'greater than and less than or equal to'.

Although the disclosure describes various embodiments using terms used in some communication standards such as the 3GPP, the embodiments are merely examples for description. Embodiments of the disclosure may be easily modified and applied to other communication systems.

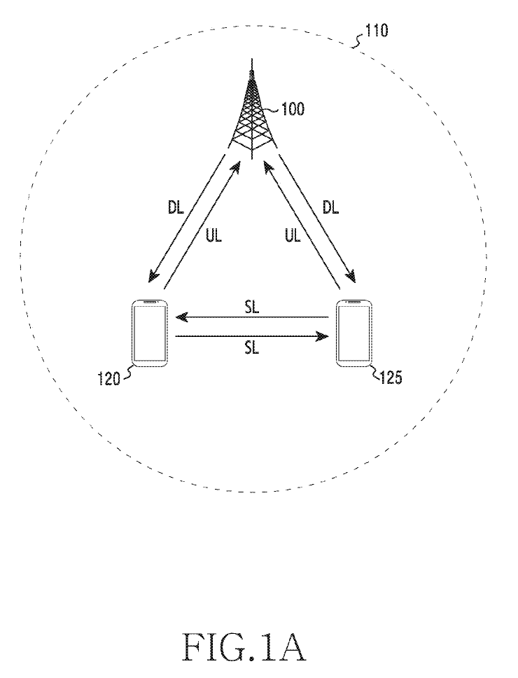

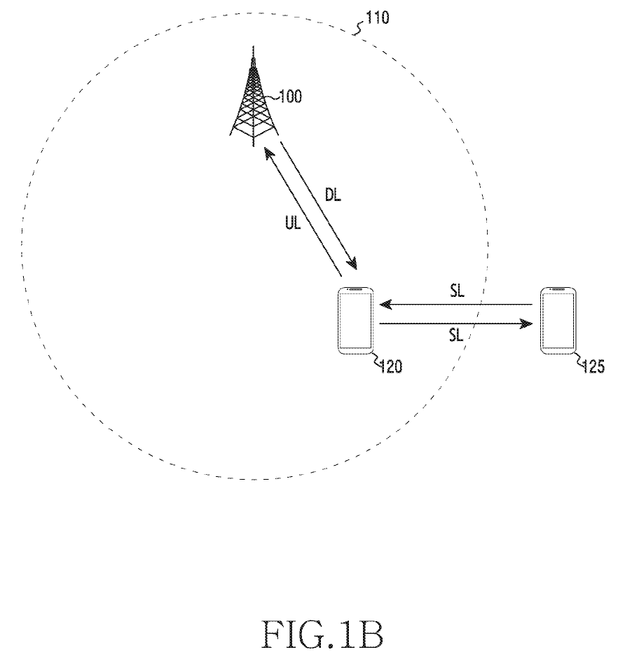

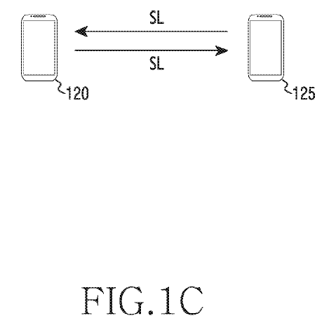

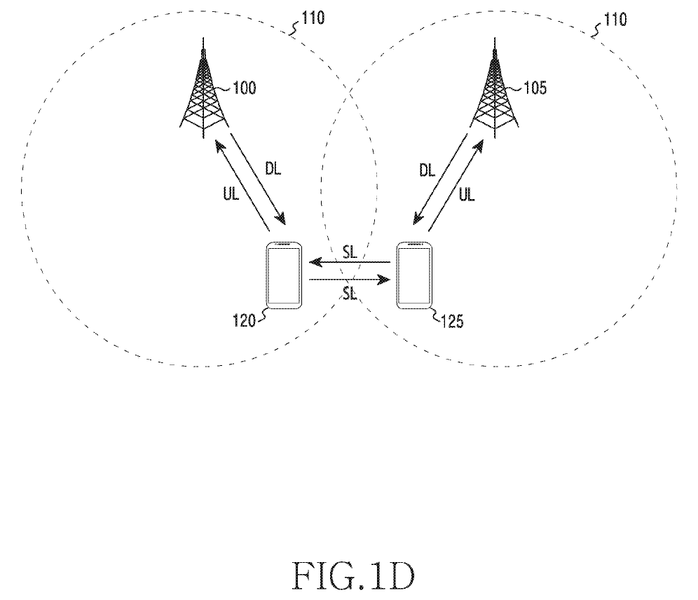

FIG. 1A illustrates a scenario associated with sidelink communication in a wireless communication system according to an embodiment. Specifically, FIG. 1A illustrates an in-coverage (IC) scenario in which sidelink UEs 120 and 125 are located in coverage 110 of a base station 100. Sidelink UEs 120 and 125 may receive data and control information from the base station in a DL or may transmit data and control information to the base station in a UL. In this instance, the data and control information may be data and control information for sidelink communication or data and control information for general cellular communication different from sidelink communication. In addition, the sidelink UEs 120 and 125 in FIG. 1A may transmit and receive data and control information for sidelink communication via a sidelink.

FIG. 1B illustrates a scenario associated with sidelink communication in a wireless communication system according to an embodiment. Specifically, FIG. 1B illustrates a partial coverage (PC) scenario in which the first UE 120 among sidelink UEs is located in the coverage 110 of the base station 100 and the second UE 125 is located outside the coverage 110 of the base station 100. The first UE 120 located in the coverage 110 of the base station 100 may receive data and control information from the base station in the DL or may transmit data and control information to the base station in the UL. The second UE 125 located outside the coverage of the base station 100 may not receive data and control information from the base station in the DL, and may not transmit data and control information to the base station in the UL. The second UE 125 may perform transmission and reception of data and control information for sidelink communication with the first UE 120 via a sidelink.

FIG. 1C illustrates a scenario associated with sidelink communication in a wireless communication system according to an embodiment. Specifically, FIG. 1C illustrates an out-of-coverage (OOC) scenario in which sidelink UEs (e.g., the first UE 120 and the second UE 125) are located outside the coverage 110 of the bases station 100. Therefore, the first UE 120 and the second UE 125 may not receive data and control information from the base station in the DL and may not transmit data and control information to the base station in an UL. The first UE 120 and the second UE 125 may perform transmission and reception of data and control information for sidelink communication via a sidelink.

FIG. 1D illustrates a scenario associated with sidelink communication in a wireless communication system according to an embodiment. Specifically, FIG. 1D illustrates an inter-cell sidelink communication performed when the first UE 120 and the second UE 125 that perform sidelink communication access (e.g., an RRC-connected state) or camp on (e.g., an RRC-disconnected state, i.e., an RRC idle state) different base stations (e.g., the first base station 100 and a second base station 105), respectively. In this instance, the first UE 120 may be a sidelink transmission UE, and the second UE 125 may be a sidelink reception UE. Alternatively, the first UE 120 may be a sidelink reception UE, and the second UE 125 may be a sidelink transmission UE. The first UE 120 may receive a sidelink-dedicated system information block (SIB) from the base station 100 that the first UE 120 accesses (or camps on), and the second UE 125 may receive a sidelink-dedicated SIB from another base station 105 that the second UE 125 accesses (or camps on). In this instance, information associated with the sidelink-dedicated SIB that the first UE 120 receives and information associated with the sidelink-dedicated SIB that the second UE 125 receives may be different from each other. Therefore, in order to perform sidelink communication between UEs located in different cells, information needs to be unified, or an assumption and interpretation method may be additionally needed.

Although the examples of FIGS. 1A to 1D provide a description based on a sidelink system including two UEs (e.g., the first UE 120 and the second UE 125), the disclosure is not limited thereto and may be applied to a sidelink system which three or more UEs partake. In addition, the UL and the DL between the base station 100 and a sidelink UE may be referred to as a Uu interface, and a sidelink between sidelink UEs may be referred to as a PC5 interface. Herein, a UL or a DL and a Uu interface may be interchangeably used, and a sidelink and PC5 may be interchangeably used.

A UE herein may be a vehicle that supports vehicle-to-vehicle (V2V) communication, a vehicle or a handset (i.e., a smartphone) of a pedestrian that supports a vehicle-to-pedestrian (V2P) communication, a vehicle that supports vehicle-to-network (V2N) communication, or a vehicle that supports vehicle-to-infrastructure (V2I) communication. In addition, a UE in the disclosure may be a road side unit (RSU) having a UE function, an RSU having a base station function, or an RSU having part of a base station function and part of a UE function.

A base station herein may support both V2X communication and general cellular communication, or may support only V2X communication. In this instance, the base station may be a 5G base station (gNB), a 4G base station (eNB), or an RSU.

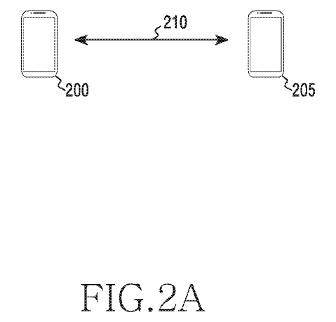

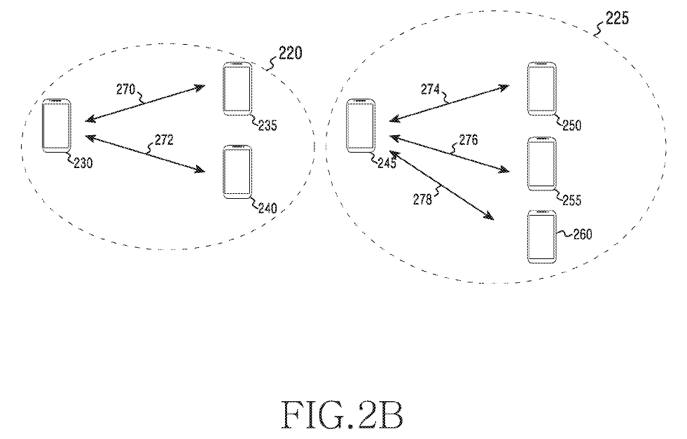

FIG. 2A illustrates a transmission scheme of sidelink communication in a wireless communication system according to an embodiment. FIG. 2B illustrates a transmission scheme of sidelink communication in a wireless communication system according to an embodiment. Specifically, FIG. 2A illustrates a unicast scheme, and FIG. 2B illustrates a groupcast scheme.

As illustrated in FIG. 2A, a transmission UE 200 and a reception UE 205 may perform one-to-one communication 210 which may be referred to as unicast communication. As illustrated in FIG. 2B, a transmission UE 230 or 245 and reception UEs 235, 240, 250, 255, and 260 may perform one-to-many communication which may be referred to as groupcast or multicast.

In FIG. 2B, the first UE 230, the second UE 235, and the third UE 240 may be grouped into a single group and perform groupcast communication 270, 272. The fourth UE 245, the fifth UE 250, the sixth UE 255, and the seventh UE 260 may be grouped into another group and perform groupcast communication 274, 276, 278. UEs may perform groupcast communication in a group that the UEs belong to, and may perform unicast, groupcast, or broadcast communication with at least one other UE that belongs to a different group. Although FIG. 2B illustrates two groups, the disclosure is not limited thereto and may be applicable to when a larger number of groups are present.

Sidelink UEs may perform broadcast communication. The broadcast communication refers to a scheme in which all sidelink UEs receive data and control information that a sidelink transmission UE transmits via a sidelink. For example, in FIG. 2B, in case that the first UE 230 is a transmission UE and the remaining UEs 235, 240, 245, 250, 255, and 260 may receive data and control information that the first UE 230 transmits.

The above-described sidelink unicast communication, groupcast communication, broadcast communication may be supported in an in-coverage scenario, a partial-coverage scenario, or an out-of-coverage scenario.

Unlike an LTE sidelink, In an NR sidelink, it is considered to support a transmission scheme in which a vehicle UE transmits data only to a single predetermined UE via unicast and a transmission scheme in which a vehicle UE transmits data to a plurality of predetermined UEs via groupcast. For example, unicast and groupcast technologies may be effectively used when a service scenario, such as platooning, is considered. Platooning is a technology in which two or more vehicles connect to a single network, and move by being bounded as a group. Specifically, a leader UE of a group bounded based on platooning may use unicast communication for the purpose of controlling a single predetermined UE, and may use groupcast communication for the purpose of simultaneously controlling a group including a plurality of predetermined UEs.

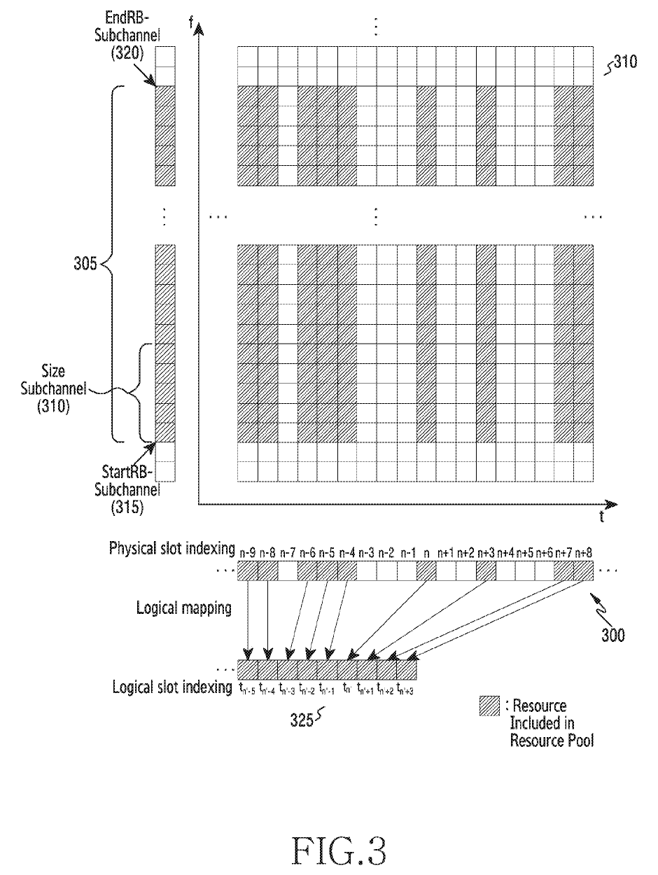

FIG. 3 illustrates a sidelink resource pool in a wireless communication system according to an embodiment. The resource pool may be defined as a set of resources in the time and frequency domain used for sidelink transmission and reception.

In the resource pool, a resource allocation unit (resource granularity) in the time axis may be one OFDM symbol or one or more OFDM symbols. A resource allocation unit in the frequency axis may be one physical resource block (PRB) or one or more PRBs.

When a resource pool is allocated in the time domain and the frequency domain, an area including resources marked with oblique lines indicates an area configured as a resource pool in the time and frequency domain. Although the disclosure teaches when a resource pool is allocated non-contiguously in the time domain, the disclosure is not limited thereto and may be applicable to when a resource pool is allocated contiguously in the time domain. In addition, although the disclosure teaches when a resource pool is allocated contiguously in the frequency domain, the disclosure is not limited thereto and may be applicable to when a resource pool is allocated non-contiguously in the frequency domain.

Referring to FIG. 3, a time domain 300 of the configured resource pool may be the case in which resources are allocated non-contiguously in the time domain. In the time domain 300 of the resource pool, a resource allocation unit (resource granularity) in the time axis may be a slot. Specifically, a single slot including 14 OFDM symbols may be a basic resource allocation unit of the time axis. Referring to the time domain 300 of the configured resource pool, shaded slots indicate slots allocated as a resource pool in the time domain, and the slots allocated as the resource pool in the time domain may be indicated based on system information. For example, the slots allocated as the resource pool in the time domain may be indicated by using time domain resource pool configuration information in an SIB. Specifically, at least one slot configured as the resource pool in the time domain may be indicated via a bitmap. In FIG. 3, physical slots 300 belonging to a non-contiguous resource pool in the time domain may be mapped to logical slots 325. Generally, a set of slots belonging to a resource pool for a physical sidelink shared channel (PSSCH) may be expressed as t₀, t₁, …, tᵢ, …, t_{Tmax}.

Referring to FIG. 3, a frequency domain 305 of the configured resource pool may be when resources are allocated contiguously in the frequency domain. In the frequency domain 305 of the resource pool, a resource allocation unit in the frequency axis may be a sub-channel 310. Specifically, a single sub-channel 310 including one or more resource blocks (RBs) may be defined as a basic resource allocation unit in the frequency domain. That is, the sub-channel 310 may be defined as an integer multiple of an RB. Referring to FIG. 3, a sub-channel size (sizeSubchannel) may include five consecutive PRBs, but the disclosure is not limited thereto and a sub-channel size may be configured to be different. In addition, although a single sub-channel generally includes consecutive PRBs, the PRBs are not necessarily consecutive. The sub-channel 310 may be a basic unit of resource allocation with respect to a PSSCH. In addition, a sub-channel for a physical sidelink feedback channel (PSFCH) may be defined independently from a PSSCH.

Referring to FIG. 3, a location where a sub-channel starts in the frequency domain in the resource pool may be indicated by startRB-Subchannel 315. When resource allocation is performed in units of sub-channels 310 in the frequency domain, a resource pool may be configured in the frequency domain via configuration information associated with an RB index (startRB-Subchannel) 315 indicating whether a sub-channel starts, information (sizeSubchannel) 310 indicating the number of RBs included in a sub-channel, and the total number of sub-channels (numSubchannel). In addition, a resource pool may be configured in the frequency domain via configuration information associated with an RB index (EndRB-Subchannel) 320 indicating where a sub-channel ends. Sub-channels allocated as a resource pool in the frequency domain may be indicated by using system information. For example, at least one of startRB-Subchannel, sizeSubchannel, EndRB-SubChannel, and numSubchannel may be indicated as frequency resource pool configuration information in an SIB. When a sub-channel for a PSFCH is defined independently from a PSSCH, sub-channel configuration information of the PSFCH and the PSSCH may be indicated respectively to a UE.

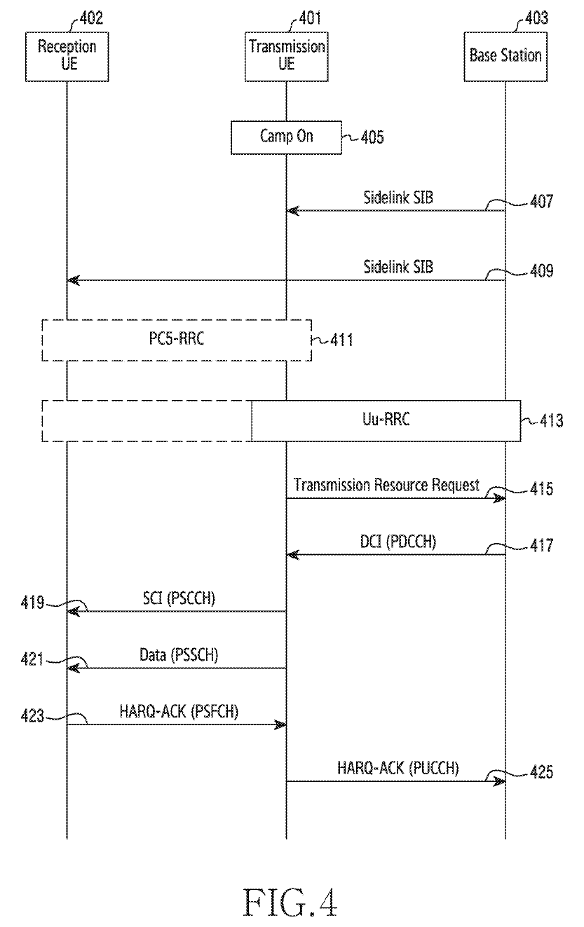

FIG. 4 illustrates a signal flow for allocating a transmission resource of a sidelink in a wireless communication system according to an embodiment. Specifically, FIG. 4 illustrates a signal exchange performed among a transmission UE 401, a reception UE 402, and a base station 403.

A scheme in which a base station allocates a transmission resource for sidelink communication will be referred to as mode 1. Mode 1 is a scheme based on resource allocation scheduled by a base station. More specifically, in resource allocation mode 1, the base station may allocate, to RRC-connected UEs, a resource for sidelink transmission according to a dedicated scheduling scheme. Since the base station is capable of managing a resource for a sidelink, scheduled resource allocation may be advantageous for managing interference and a resource pool (e.g., dynamic allocation and/or semi-persistent transmission).

Referring to FIG. 4, in step 40e, the transmission UE 401 camps on a cell. In step 407, the transmission UE 401 that camps on the cell in step 405 may receive a sidelink SIB from the base station 403. In step 409, the reception UE 402 may receive a sidelink SIB from the base station 403. The reception UE 402 receives data transmitted from the transmission UE 401. A sidelink SIB may be transmitted periodically or on demand and may include at least one piece of information among sidelink resource pool information for sidelink communication, parameter configuration information for a sensing operation, information for configuring sidelink synchronization, or carrier information for sidelink communication operating in different frequencies. Although steps 407 and 409 have been described sequentially, this is merely for ease of description, steps 407 and 409 may be performed in parallel.

In step 413, when data traffic for sidelink communication is produced in the transmission UE 401, the transmission UE 401 may be RRC-connected to the base station 403 and may be referred to as Uu-RRC. The Uu-RRC connection may be performed before data traffic of the transmission UE 401 is performed. In mode 1, when a Uu-RRC connection is established between the base station 403 and the reception UE 402, the transmission UE 401 may perform transmission to the reception UE 402 in a sidelink. In mode 1, even when a Uu-RRC connection is not established between the base station 403 and the reception UE 402, the transmission UE 401 may perform transmission to the reception UE 402 in a sidelink.

In step 415, the transmission UE 401 may request, from the base station 403, a transmission resource for performing sidelink communication with the reception UE 402. In this instance, the transmission UE 401 may request, from the base station 403, a transmission resource for a sidelink by using at least one of a physical UL control channel (PUCCH), an RRC message, or an MAC CE. When the MAC CE is used, the MAC CE may be related to a buffer state report provided in a new form including at least one piece of information among an indicator indicating a buffer status report (BSR) for sidelink communication and information associated with the size of data stored in a buffer for device-to-device (D2D) communication (or V2X communication). The MAC CE may be referred to as a sidelink BSR MAC CE. When a PUCCH is used, the transmission UE 401 may request a sidelink resource by using a bit of a scheduling request (SR) transmitted via a PUCCH.

In step 417, the base station 403 may transmit DL control information (DCI) to the transmission UE 401 via a PDCCH. That is, the base station 403 may indicate, to the transmission UE 401, final scheduling for sidelink communication with the reception UE 402. The base station 403 may allocate a sidelink transmission resource to the transmission UE 401 according to at least one of a dynamic grant (DG) scheme or a configured grant (CG) scheme.

In the DG scheme, the base station 403 may transmit DCI to the transmission UE 401 and may allocate a resource for transmission of a single transport block (TB). Sidelink scheduling information included in the DCI may include a parameter related to an initial transmission point and/or retransmission point, and a parameter related to a frequency allocation location information field. The DCI for the dynamic grant scheme may be cyclic redundancy check (CRC) scrambled based on a sidelink-v2x-radio network temporary identifier (SL-V-RNTI) for indicating that a transmission resource allocation scheme is a dynamic grant scheme.

In the CG scheme, a semi-persistent scheduling (SPS) interval is configured in Uu-RRC and thus, a resource for transmitting a plurality of TBs may be periodically allocated. In this instance, the base station 403 may transmit DCI to the transmission UE 401 and may allocate the resource for the plurality of TBs. Sidelink scheduling information included in the DCI may include a parameter related to an initial transmission point and/or retransmission point, and a parameter related to a frequency allocation location information field. In the configured grant scheme, an initial transmission point (occasion) and/or retransmission point and a frequency allocation location may be identified based on the transmitted DCI, and the resource may be repeated at intervals of SPS. The DCI for the configured grant scheme may be CRC scrambled based on an SL-SPS-V-RNTI in order to indicate that a transmission resource allocation scheme is a configured grant scheme. In addition, the configured grant scheme may be classified as type 1 CG and type 2 CG. In the type 2 CG, the base station 403 may perform activation and/or deactivation of a resource configured by the configured grant via DCI. Therefore, In mode 1, the base station 403 may transmit DCI via a PDCCH, so as to indicate, to the transmission UE 401, final scheduling for sidelink communication with the reception UE 402.

In step 419, when broadcast transmission is performed between the UEs 401 and 402, the transmission UE 401 broadcasts SCI to the reception UE 402 via a PSCCH without the additional sidelink RRC configuration of step 411. In step 421, the transmission UE 401 may broadcast data to the reception UE 402 via a PSSCH.

When unicast or groupcast transmission is performed between the UEs 401 and 402, the transmission UE 401 may establish one-to-one RRC connection with other UEs (e.g., the reception UE 402) in step 411. In this instance, to distinguish from Uu-RRC, the RRC connection between 401 and 402 may be referred to as PC5-RRC. In a groupcast transmission scheme, a PC5-RRC connection may be individually configured between the UEs in a group. In FIG. 4, although the PC5-RRC connection of step 411 is illustrated as an operation subsequent to transmission of a sidelink SIB (in steps 407 and 409), PC5-RRC connection in step 411 may be performed before transmission of a sidelink SIB or before broadcast of SCI in step 419. When an RRC connection between UEs is needed, a PC5-RRC connection of a sidelink is established, the transmission UE 401 may transmit SCI to the reception UE 402 via a PSCCH according to unicast or groupcast in step 419. In this instance, groupcast transmission of the SCI may be understood as a group SCI.

More specifically in step 421, the transmission UE 401 may transmit data to the reception UE 402 via a PSSCH according to unicast or groupcast. In mode 1, the transmission UE 401 may identify sidelink scheduling information included in DCI received from the base station 403, and may perform, based on the sidelink scheduling information, scheduling of a sidelink. SCI may include scheduling information such as a field related to an initial transmission and retransmission point and frequency allocation location information, a new data indicator (NDI) field, a redundancy version (RV) field, and an information field for indicating a reservation interval.

An information field for indicating a reservation interval indicates a single fixed value as an interval between TBs when a resource for a plurality of TBs (i.e., a plurality of MAC protocol data units (PDUs)) is selected, and may indicate '0' as a value of the interval between TBs when a resource for a single TB is selected.

In step 423, the reception UE 402 may transmit an indication, to the transmission UE 401, of whether the data received in step 421 is successfully demodulated/decoded to the transmission UE 401 via first HARQ feedback information including ACK (success) or NACK (failure) information. The reception UE 402 may transfer the first HARQ feedback information to the transmission UE 401 via a PSFCH channel.

In step 425, based on first HARQ feedback information received from the reception UE 402, the transmission UE 401 may transmit a transmission result to the base station 403 as second HARQ feedback information, via a PUCCH. The second HARQ feedback information may be the same as or different from the first HARQ feedback information and may include a plurality of pieces of first HARQ feedback information. The plurality of pieces of first HARQ feedback information may include a plurality of pieces of HARQ feedback information received from a single reception UE or may include a single or multiple pieces of HARQ feedback information received from multiple UEs. Via the second HARQ feedback information, the base station may allocate a resource for retransmission to the transmission UE 401, may allocate a resource for new transmission, or may stop resource allocation when no transmission resource allocable to the transmission UE 401 is present. A resource for transmission of a PUCCH in step 425 may be identified based on DCI information that the base station transmits to the transmission UE via a PDCCH in step 417, based on SCI of the PSCCH of step 419, or based on a transmission resource area in which the PSSCH is transmitted or received in step 421.

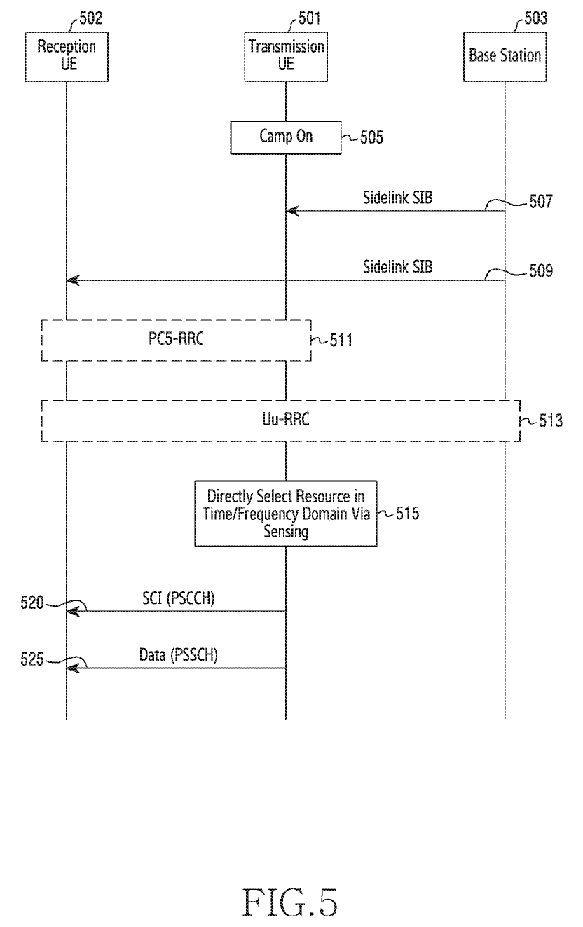

FIG. 5 illustrates a signal flow for allocating a transmission resource of a sidelink in a wireless communication system according to an embodiment. FIG. 5 illustrates signal exchange performed among a transmission UE 501, a reception UE 502, and a base station 503.

Specifically, FIG. 5 illustrates a scheme in which a UE directly allocates a sidelink transmission resource via sensing, referred to as mode 2 or UE autonomous resource selection. In mode 2, the base station 503 may provide a sidelink transmission or reception resource pool for a sidelink to a UE via system information or an RRC message (e.g., RRC reconfiguration (RRCReconfiguration) message, PC5 RRC message), and the transmission UE 501 may select a resource pool and a resource according to a rule defined. Unlike mode 1 in which a base station is directly involved in resource allocation as described in FIG. 4, the transmission UE 501 in mode 2 may autonomously select, based on a resource pool received in advance via system information, a resource and may transmit data.

Referring to FIG. 5, in step 505, the transmission UE 501 in a camp-on state with a cell. In step 507, the transmission UE 501 in the camp-on state may receive a sidelink SIB from the base station 503. In step 509, the reception UE 502 may receive a sidelink SIB from the base station 503. The reception UE 502 receives data transmitted from the transmission UE 501. A sidelink SIB may be transmitted periodically or on demand. The sidelink SIB information may include at least one piece of information among sidelink resource pool information for sidelink communication, parameter configuration information for a sensing operation, information for configuring sidelink synchronization, or carrier information for sidelink communication operating in different frequencies. Although steps 507 and 509 have been described sequentially, this is merely for ease of description, and steps 507 and 509 may be performed in parallel.

In step 511, when unicast or groupcast transmission is performed between the UEs 501 and 502, the transmission UE 501 may establish one-to-one RRC connection with the reception UE 502. In this instance, to distinguish from Uu-RRC, the RRC connection between 501 and 502 may be referred to as PC5-RRC. In the case of groupcast transmission scheme, a PC5-RRC connection may be individually configured between the UEs in a group.

In step 513, the base station 503 and the transmission UE 501 may perform mode 2-based sidelink communication even in an idle mode in which RRC is not connected. In FIG. 4, the base station 403 and the transmission UE 401 operate in an RRC-connected state. Conversely, the base station 503 and the transmission UE 501 in FIG. 5 may perform in step 513 irrespective whether RRC is established between the base station 503 and the transmission UE 501. Even in an RRC-connected state, the base station 503 may not be directly involved in resource allocation, and may operate such that the transmission UE 501 autonomously selects a transmission resource. In this instance, an RRC connection between the transmission UE 501 and the base station 503 may be referred to as Uu-RRC.

In step 515, when data traffic for sidelink communication is produced in the transmission UE 501, the transmission UE 501 may be configured with a resource pool via system information received from the base station 503, and may directly select a resource in the time and frequency domain via sensing in the configured resource pool.

In step 520, when broadcast transmission is performed between the UEs 501 and 502, the transmission UE 501 broadcasts SCI to the reception UE 502 via a PSCCH without additional sidelink RRC configuration of step 513. In step 525, the transmission UE 501 may broadcast data to the reception UE 502 via a PSSCH.

In FIG. 5, the PC5-RRC connection is illustrated as being performed subsequent to transmission of a sidelink SIB (in steps 507 and 509). However, the PC5-RRC connection of step 511 may be established before transmission of a sidelink SIB or before transmission of SCI in step 520. When RRC connection between UEs is needed, PC5-RRC connection of a sidelink may be established, and the transmission UE 501 may transmit SCI to the reception UE 502 via a PSCCH according to unicast or groupcast in step 520. In this instance, groupcast transmission of SCI may be understood as group SCI. In step 525, the transmission UE 501 may transmit data to the reception UE 502 via a PSSCH according to unicast or groupcast. In mode 2, the transmission UE 501 performs sensing and transmission resource selection, so as to directly perform scheduling in association with a sidelink. SCI may include scheduling information such as an initial transmission and retransmission point, and frequency allocation location information field, an NDI field, an RV field, and an information field for indicating a reservation interval.

An information field for indicating a reservation interval may indicate a single fixed value as an interval between TBs when a resource for a plurality of TBs (i.e., a plurality of MAC PDUs) is selected, and may indicate '0' as a value of the interval between TBs when a resource for a single TB is selected.

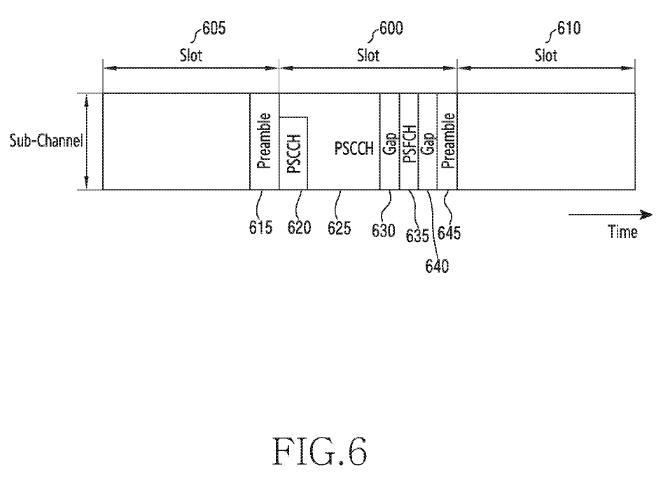

FIG. 6 illustrates a structure of a channel of a slot used for sidelink communication in a wireless communication system according to an embodiment. Specifically, FIG. 6 illustrates physical channels mapped to a slot for sidelink communication.

Referring to FIG. 6, a preamble 615 is mapped to the end part of a previous slot 605 before the start of a slot 600. Subsequently, from the start of the slot 600, a PSCCH 620, a PSSCH 625, a gap 630, a PSFCH 635, and a gap 640 are mapped sequentially.

Before transmitting a signal in the corresponding slot 600, a transmission UE may transmit the preamble 615 in one or more symbols. The preamble 615 may be used so that a reception UE appropriately performs automatic gain control (AGC) for controlling the intensity of amplification when the reception UE amplifies power of a reception signal. In addition, the preamble 615 may or may not be transmitted depending on whether the previous slot 605 of the transmission UE is transmitted. That is, when the transmission UE transmits a signal to the same UE in the previous slot 605 of the corresponding slot 600, transmission of the preamble 615 may be omitted. The preamble 615 may be referred to as a synchronization signal, sidelink synchronization signal, sidelink reference signal, midamble, initial signal, wake-up signal, or another term having an equivalent technical meaning.

The PSCCH 620 including control information may be transmitted using symbols that are transmitted early in the slot, and subsequently, the PSSCH 625 scheduled by the control information of the PSCCH 620 may be transmitted. At least part of SCI that is control information may be mapped to the PSSCH 625. Subsequently, the gap 630 is present, and the PSFCH 635 that is a physical channel for transmitting feedback information is mapped.

FIG. 6 illustrates that the PSFCH 635 is located in the last part of the slot. By securing the gap 630 that is a predetermined free time between the PSSCH 625 and the PSFCH 635, a UE that transmits or receives the PSSCH 625 may prepare (e.g., switch transmission or reception) for transmission or reception of the PSFCH 635. After the PSFCH 635, the gap 640 that corresponds to a predetermined free time may be present.

The location of a slot capable of transmitting a PSFCH may be previously configured for the UE in a procedure in which the configuration is previously determined/identified during a process of manufacturing the UE, the configuration is delivered when the UE accesses a sidelink-related system, the configuration is delivered from a base station when the UE accesses the base station, or the configuration is delivered from another UE.

FIG. 6 illustrates a preamble signal for performing AGC being separately transmitted in a physical channel structure in a sidelink slot. Alternatively, instead of transmission of a separate preamble signal, it is also possible that a receiver of the reception UE receives a physical channel for control information or data transmission and performs AGC operation by using the physical channel for control information or data transmission.

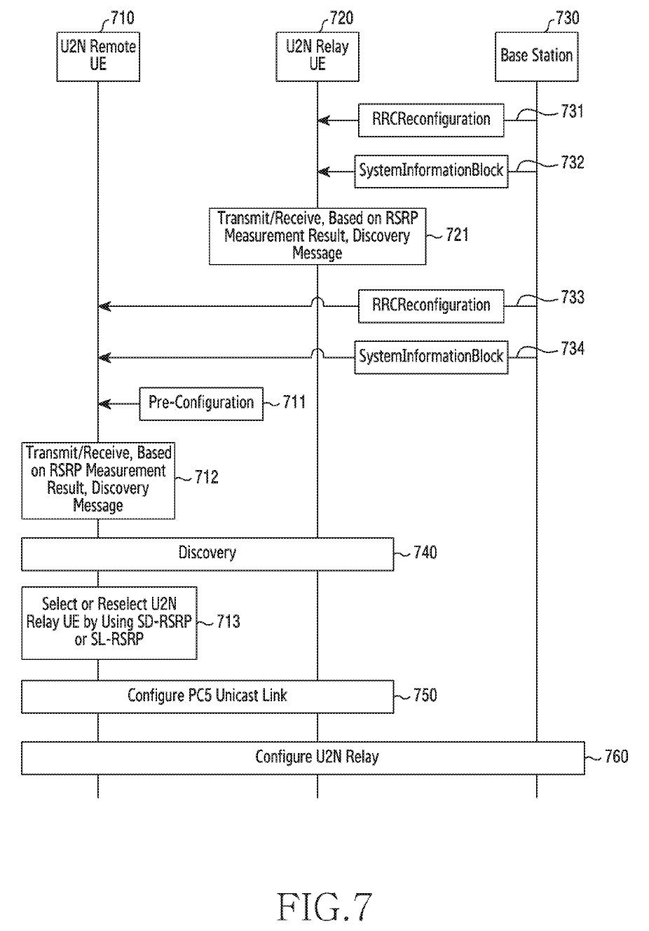

FIG. 7 illustrates a configuration of a U2N relay according to an embodiment.

In 3GPP release 16 (Rel-16), standardization has been performed by focusing on a V2X-related road safety service for a first version of NR sidelink. Subsequently, in 3GPP release 17 (Rel-17), standardization of a U2N relay has been performed in consideration of various services so as to enlarge sidelink or network coverage via a sidelink-based relay, and to increase the efficiency of power of a UE.

Referring to FIG. 7, in step 731, a UE (U2N relay UE) 720 that supports a U2N relay operation in a U2N relay may be configured, by a base station 730 by receiving an RRC message, so as to provide a U2N relay service. In step 732, the U2N relay UE may obtain, via an SIB message, information indicating that the corresponding base station 730 is capable of providing a U2N relay service.

In step 721, to transfer information to a neighboring UE (U2N remote UE) 710 that needs to receive a U2N relay service and supports U2N remote operation, the U2N relay UE 720 may transmit or receive a discovery message 740 according to a result of measurement of reference signal received power (RSRP) associated with a base station. In step 740, an RSRP criterion for transmission or reception of the discovery message by the U2N relay UE 720 may be configured for the U2N relay UE 720 via the above-described RRC message in step 731 or the SIB message in step 732. In association with the RSRP criterion, the RRC message in step 731 or the SIB message in step 732 may include information associated with at least one of threshHighRelay and hystMaxRelay so that the discovery message in step 740 is transmitted or received when a value obtained in consideration of an RSRP measurement result associated with the base station 730 together with hysteresis is above a threshold, and the RRC message in step 731 or the SIB message in step 732 may include information associated with at least one of threshLowRelay and hystMinRelay so that the discovery message 740 is not transmitted or received when a value obtained in consideration of an RSRP measurement result associated with the base station 730 together with hysteresis is below a threshold.

In step 733, in a U2N relay, the U2N remote UE 710 may be configured by the base station 730 via the RRCreconfiguration message, so as to operate as a U2N remote UE. In step 734, the U2N remote UE 710r may obtain, via the SIB message, information needed for operating as a U2N remote UE.

In step 711, the U2N remote UE 710 that does not have a serving cell may use information which is pre-configured and is needed for operating as a U2N remote UE.

In step 712, based on an RSRP measurement result associated with the base station 730, the U2N remote UE 710 may transmit or receive the discovery message 740 in order to discover and select or reselect the U2N relay UE 720. In this instance, the U2N remote UE that does not have a serving cell may always transmit or receive the discovery message 740 for U2N relay. In step 740, an RSRP criterion for transmission or reception of the discovery message by the U2N remote UE may be configured for the U2N remote UE 710 via the above-described RRC message in step 733 or SIB message in step 734. A threshHighRemote and hystMaxRemote message may be included so that the discovery message in step 740 is transmitted or received when a value obtained in consideration of the RSRP measurement result associated with a base station together with hysteresis is below a threshold.

In step 713, the U2N remote UE 710 may use a sidelink discovery RSRP(SD-RSRP) or sidelink RSRP (SL-RSRP) measurement result associated with the U2N relay UE 720 in order to select or reselect the U2N relay UE 720 discovered via the discovery message in step 740. Although there may be one or more U2N relay UEs, one U2N relay UE 720 is illustrated for ease of description. An SD-RSRP or SL-RSRP criterion for considering the U2N relay UE 720 discovered by the U2N remote UE 710 as a candidate for selection or reselection may be configured for the U2N remote UE 710 via the above-described RRC message in step 733, the SIB message in step 734 or the pre-configuration in step 711. the RRC message in step 733 or the SIB message in step 734 may further include information associated with sl-FilterCoefficientRSRP, sl-RSRP-Thresh, sl-HystMin, and the like so that the U2N relay UE 720 is considered as a candidate for selection or reselection when a value obtained in consideration of an SD-RSRP or SL-RSRP measurement result, obtained by applying layer-3 filtering using sl-FilterCoefficientRSRP in association with the U2N relay UE 720, together with hysteresis is above a threshold.

In step 750, a condition for selecting or reselecting a U2N relay UE by the U2N remote UE 710 by using an SD-RSRP or SL-RSRP is for preparation of the minimum criterion for coverage by the U2N remote UE 710 and the U2N relay UE 720 for configuring a PC5 unicast link. In step 760, a condition for selecting or reselecting a U2N relay UE by the U2N remote UE 710 by using an SD-RSRP or SL-RSRP is for preparation of the minimum criterion for coverage by the U2N remote UE 710 and the U2N relay UE 720 for configuring a U2N relay. The term configuring may be used to indicate the same meaning as configuration. In step 7670, to use a U2N relay service via the selected U2N relay UE 720, the U2N remote UE 710 may configure a PC5 unicast link. In step 750, the PC5 unicast link is configured for communication between the U2N remote UE 710 and the selected U2N relay UE 720. In step 760, the U2N relay is configured among a U2N remote UE 770, the U2N relay UE 720, and the base station 730 for providing a U2N relay service.

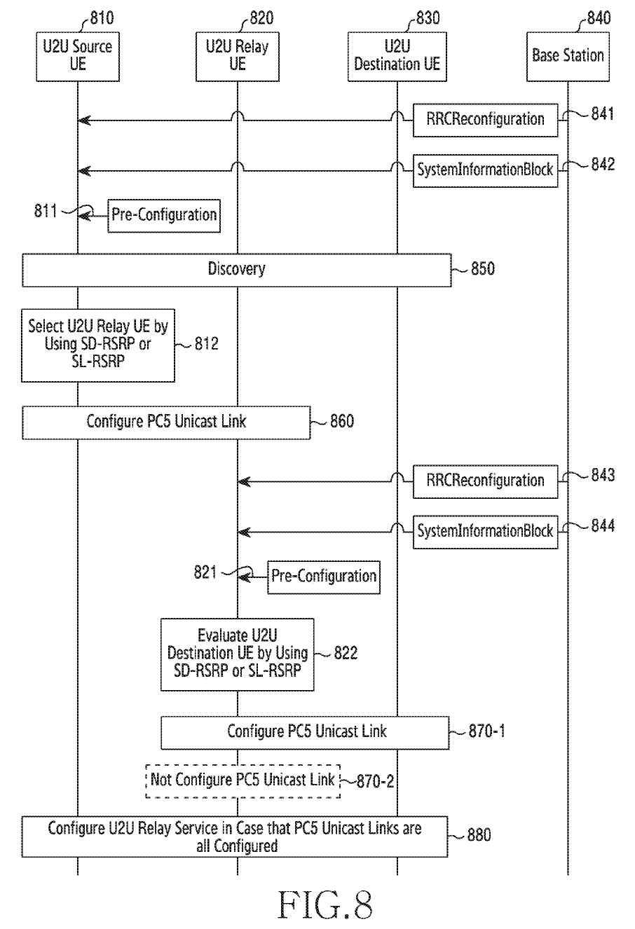

FIG. 8 illustrates a configuration of a U2U relay according to an embodiment.

Referring to FIG. 8, a U2U relay service may be performed by subjects including a U2U destination UE 830 that provides a U2U service, a U2U source UE 810 that needs to communicate with the U2U destination UE 830 to receive a U2U service, and a U2U relay UE 820 that supports a U2U relay operation and relays a message between the U2U source UE 810 and the U2U destination UE 830. In FIG. 8, although there may be one or more U2U source UEs 810, U2U relay UEs 820, and the U2U destination UEs 830 may be present, one U2U source UE 810, one U2U relay UE 820, and one U2U destination UE 830 are illustrated for ease of description.

In step 811, an SD-RSRP or SL-RSRP criterion for considering the U2U relay UE 820 as a candidate for selection or reselection by the U2U source UE 810 may be configured for the U2U source UE 810 via an RRC message in step 841 or SIB message in step 842 transmitted by a base station 840, or may be configured for the U2U source UE 810 via a pre-configuration.

In step 812, when the U2U source UE 810 discovers the U2U destination UE 830 via a discovery procedure 850 and needs to communicate with the U2U destination UE 830, the U2U source UE 810 may use an SD-RSRP or SL-RSRP measurement result associated with the U2U relay UE 820 in order to select or reselect the U2U relay UE 820.

In association with the SD-RSRP or SL-RSRP criterion, the RRC message in step 841 or the SIB message in step 842 may include information associated with at least one of sl-FilterCoefficientRSRP, sl-RSRP-Thresh, and sl-HystMin so as to consider the U2U relay UE 820 as a candidate for selection or reselection when a value obtained in consideration of an SD-RSRP or SL-RSRP measurement result, obtained by applying layer-3 filtering by using sl-FilterCoefficientRSRP in association with the U2U relay UE 820, together with hysteresis is above a threshold. The configuration may be the same as the configuration described in FIG. 7, or may be configured differently for each UE, each cell, or each resource pool by using different parameters. A condition for selecting or reselecting the U2U relay UE 820 by using an SD-RSRP or SL-RSRP in step 812 is for preparation of the minimum criterion for coverage between the U2N source UE 810 and the U2N relay UE 820 for configuring a PC5 unicast link with the U2N relay UE in step 860 and using the same after the discovery procedure in step 850.

In step 860, to communicate with the U2U destination UE 830 via the selected U2U relay UE 820, the U2U source UE 810 may configure a PC5 unicast link with the U2U relay UE 820. In step 870, the selected U2U relay UE 820 may configure a PC5 unicast link with the U2U destination UE 830 to communicate with the U2U destination UE 830 selected by the U2U source UE 810. In step 822, when proceeding with the PC5 unicast link configuration of operation 870 to communicate with the U2U destination UE 830, the U2U relay UE 820 may evaluate the U2U destination UE 830 by using an SD-RSRP or SL-RSRP criterion.

In step 870-1, when the U2U relay UE 820 identifies that an SD-RSRP or SL-RSRP criterion for configuring a PC5 unicast link with the U2U destination UE 830 is satisfied, the U2U relay UE 820 may configure the PC5 unicast link with the U2U destination UE 830.

In step 870-2, when the U2U relay UE 820 identifies that an SD-RSRP or SL-RSRP criterion for selecting the U2U destination UE 830 is not satisfied, the U2U relay UE 820 may not configure a PC5 unicast link with the U2U destination UE 830, and configuring a U2U relay requested by the U2U source UE 810 may fail.

The order of step 860 for configuring a PC5 unicast link between the U2U source UE 810 and the U2U relay UE 820 and step 822 for evaluation, by the U2U relay UE 820, for configuring a PC5 unicast link with the U2U destination UE 830 may be different from of the illustration of FIG. 8 and the above description. When configuring the PC5 unicast link between the U2U relay UE 820 and the U2U destination UE 830 is not performed in step 870-2, configuring the PC5 unicast link between the U2U source UE 810 and the U2U relay UE 820 may also not be performed. In step 880, when both the PC5 unicast link between the U2U source UE 810 and U2U relay UE 820 and the PC5 unicast link between the U2U relay UE 820 and U2U destination UE 830 are configured in steps 860 and 870-1, configuring a U2U relay may be performed.

Configuring the PC5 unicast links in step 860 and 870-1 and configuring the U2U relay service in step 880 for communication among the U2U source UE 810, the U2U relay UE 820, and the U2U destination UE 830 may comply with the appropriate standard specification, and a detailed description thereof will be omitted. Although the U2U source UE 810, the U2U destination UE 830, and the U2U relay UE 820 are described as separate entities for ease of description in the disclosure, a UE in a U2U relay may be configured without classifying, based on a UE operation method, a UE as the U2U source UE 810, the U2U destination UE 830, and the U2U relay UE 820, or a UE may be configured by classifying a UE as the U2U relay UE 820 or the U2U UEs 810 and 830 that operate other steps.

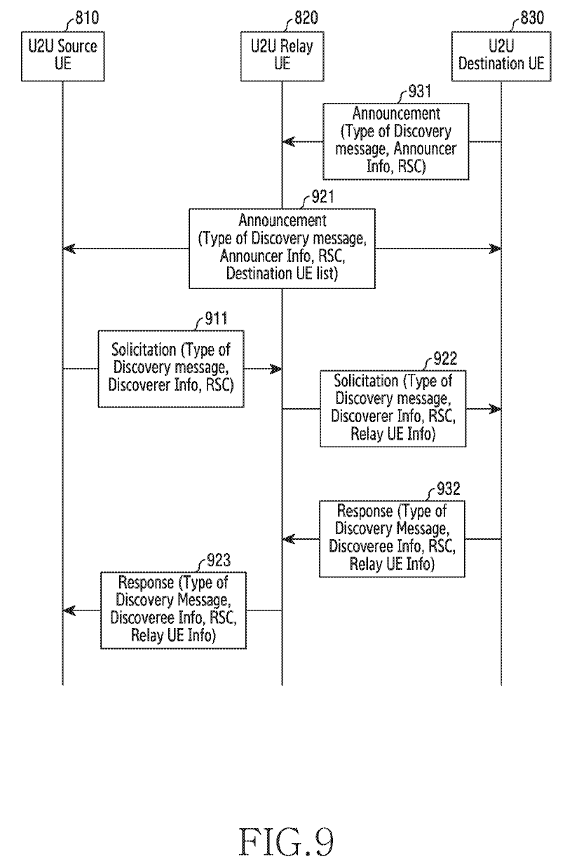

FIG. 9 illustrates a discovery procedure using a discovery message in a U2U relay according to an embodiment.

Referring to FIG. 9, a discovery message may be classified as an announcement message, a solicitation message, and a response message, and the discovery message may include other types of message that are not disclosed in the disclosure. The discovery message may comply with the definition in the standard specification, and two models (model A and model B) may be supported in U2U relay discovery.

The announcement message used in model A may include one or more pieces of information among the type of discovery message, announcer info, and relay service code (RSC). In step 931,the U2U relay UE 820 receives an announce message transmitted by the U2U destination UE 830, and may obtain service information provided by the U2U destination UE 830 via information included in the announce message transmitted by the U2U destination UE 830.

In step 921, when the U2U relay UE 820 receives the announcement message transmitted by at least one U2U destination UE 830, the U2U relay UE 820 may include, in an announcement message transmitted from the U2U relay UE 820, information obtained from the announcement message received from the U2U destination UE 830 in step 931. Examples of such the information may include one or more among the type of discovery message, announcer Info, RSC, and a U2U destination UE communicable via a U2U relay.

When the U2U destination UE 830 may receive the announcement message transmitted by the U2U relay UE 820 in step 921, and identifies that updating (adding or correcting the content) of the announcement message transmitted from the U2U relay UE 820 is required, the U2U destination UE 830 may re-transmit the announcement message in step 931 and inform the U2U relay UE 820 of the same. The U2U source UE 810 may receive the announcement message transmitted by the U2U relay UE 820 in step 921 and discover the U2U destination UE 830, and may proceed with configuring for communication with the U2U destination UE 830 via a U2U relay according to the method described in FIG. 8.

The solicitation message used in model B may include one or more pieces of information among the type of discovery message, discoverer Info, or RSC. The response message used in model B may include one or more pieces of information among the type of discovery message, discoveree Info, or RSC. In step 911, the U2U relay UE 820 receives a solicitation message 911 transmitted by the U2U source UE 810, and may obtain service information required by the U2U source UE 810 via information included in the solicitation message received from the U2U source UE 810 in step 911. In step 922, when the U2U relay UE 820 receives the solicitation message transmitted by at least one U2U source UE 810 in step 911, the U2U relay UE 820 may include, in an solicitation message transmitted from the U2U relay UE 820, information obtained from the solicitation message 911 received from the U2U source UE 810. Examples of such the information may include one or more among the type of discovery message, discoverer Info, relay UE Info, and RSC.

In step 932, the U2U destination UE 830 that receives the solicitation message transmitted by the U2U relay UE 820 may obtain service information required by the U2U source UE 810 via information included in the solicitation message transmitted by the U2U relay UE 820, and may transmit a response message via the U2U relay UE 820 in response to the U2U source UE 810. The U2U destination UE 830 includes information obtained from the solicitation message received from the U2U relay UE 820 in the response message 932 transmitted to the U2U source UE 810 via the U2U relay UE 820. Examples of such the information may include one or more among the type of discovery message, discoveree Info, RCS, or relay UE Info. In step 923, the U2U source UE 810 may receive the response message transmitted by the U2U relay UE 820 and discover the U2U destination UE 830, and may proceed with configuration (or configuring) for a U2U relay with the U2U destination UE 830 according to the method described in FIG. 8.

The announcement, solicitation, and response messages described above are types of discovery messages and are used for distinguishing a discovery message in a higher layer. In a lower layer, a discovery message is identified based on a sidelink radio bearer (SLRB) or a logical channel identity (LCID) of a sidelink control channel (SL-SCH) according to the standard specification. A discovery message expressed in the disclosure is not limited only to the announcement, solicitation, and response messages, and is easily changed and applied to other types of discovery messages.

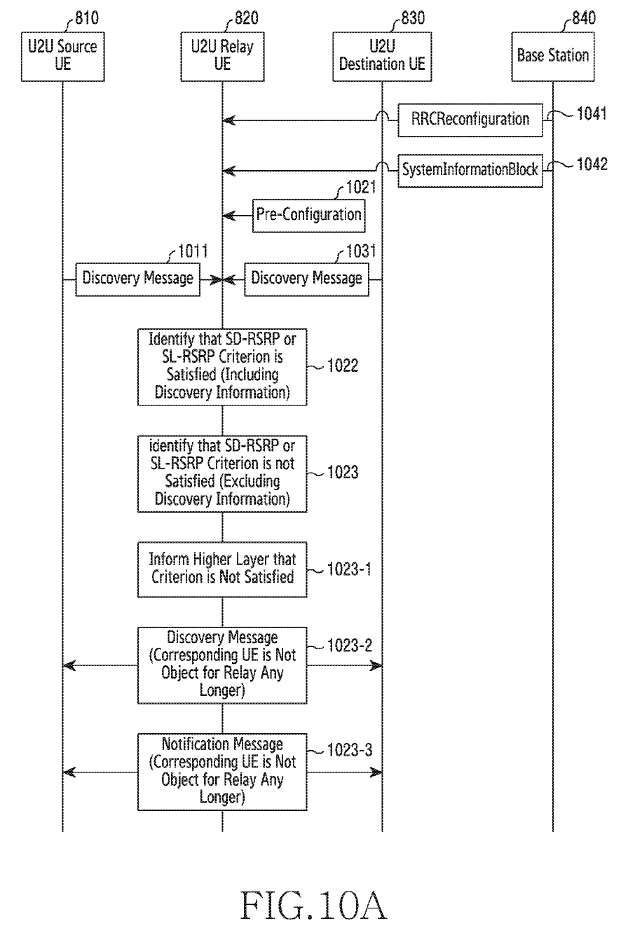

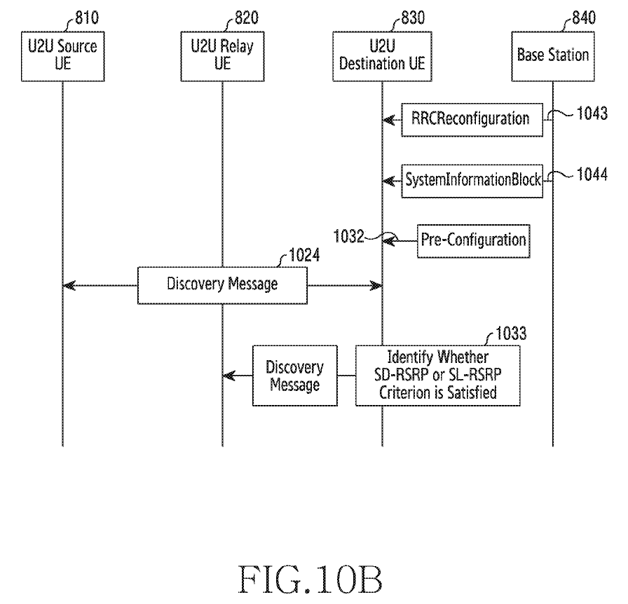

FIG. 10A illustrates a transmission of a discovery message in a U2U relay according to an embodiment.

As described in FIG. 8, a U2U destination UE selected by a U2U source UE may not satisfy an SD-RSRP or SL-RSRP criterion used by a U2U relay UE for considering the U2U destination UE as a candidate for selection. This may imply that information associated with a U2U destination UE that the U2U relay UE does not consider as a candidate for selection may be included in a discovery message transmitted by the U2U relay UE. Therefore, the U2U source UE may fail to configure a U2U relay or may request configuring a U2U relay associated with a U2U destination UE that has a poor SD-RSRP or SL-RSRP. To overcome this drawback, a U2U source UE, a U2U relay UE, and a U2U destination UE may use an SD-RSRP or SL-RSRP for identifying whether to transmit or receive a discovery message in the procedure that has been described with reference to FIG. 9.

Referring to FIG. 10A, in step 1022, the U2U relay UE 820 may use an SD-RSRP or SL-RSRP measurement result associated with the U2U source UE 810 or the U2U destination UE 830 in order to identify a discovery message 1011 and 1031 transmitted by the U2U source UE 810 or the U2U destination UE 830 as a relay object discovery message. When the discovery message 1011 and 1031 transmitted by the U2U source UE 810 or the U2U destination UE 830 is identified as being a relay object discovery message in step 1022, the U2U relay UE 820 may operate according to the procedure described with reference to FIG. 9. An SD-RSRP or SL-RSRP criterion may be configured for the U2U relay UE 820 via an RRC message in step 1041 or an SIB message in step 1042 transmitted by the base station 840, or may be configured for the U2U relay UE 820 via a pre-configuration in step 1021. In association with the SD-RSRP or SL-RSRP criterion, the RRC message in step 1041 or the SIB message in step 1042 may include information associated with at least one of sl-FilterCoefficientRSRP, sl-RSRP-Thresh, and sl-HystMin so as to identify the received discovery message 1011 and 1031 as an object for relay in step 1022 when a value obtained in consideration of an SD-RSRP or SL-RSRP measurement result, obtained by applying layer-3 filtering by using sl-FilterCoefficientRSRP in association with the U2U source UE 810 or the U2U destination UE 830, together with hysteresis, is above a threshold. The information may be the same as the configuration described with reference to FIGS. 7 or 8, or may be configured differently for each UE, each cell, or each resource pool by using different parameters.

In step 1023, the U2U relay UE 820 identifies that the discovery message 1011 and 1031 transmitted by the U2U source UE 810 or the U2U destination UE 830 does not satisfy the SD-RSRP or SL RSRP criterion, by using at least one value of sl-RSRP-Thresh or sl-HystMin configured in step 1021, step 1041, or step 1042.

In step 1023-1, the U2U relay UE 820 may not identify the corresponding discovery message in step 1011 and step 1031 as an object for relay any longer, and may report the same to a higher layer so that information related thereto is not to be included. In step 1023-2, the U2U relay UE 820 may include, in a discovery message, information indicating that the SD-RSRP or SL-RSRP of the U2U source UE 810 or the U2U destination UE 830 does not satisfy a criterion for an object for relay, so as to report the same to neighboring UEs. In step 1023-3, the U2U relay UE 820 may include, in a message 1023-3 of a different type, information indicating that the SD-RSRP or SL-RSRP of the U2U source UE 810 or the U2U destination UE 830 does not satisfy a criterion for an object for relay, so as to report the same to neighboring UEs.

FIG. 10B illustrates a transmission of a discovery message in a U2U relay according to an embodiment.

Referring to FIG. 10B, in step 1033, the U2U destination UE 830 may use an SD-RSRP or SL-RSRP measurement result associated with the U2U relay UE 820 in order to identify whether to respond to a discovery message transmitted by the U2U relay UE 820 in step 1024. An SD-RSRP or SL-RSRP criterion may be configured for the U2U destination UE 830 via an RRC message in step 1043 or an SIB message in step 1044 transmitted by the base station 840, or may be configured for the U2U destination UE 830 via a pre-configuration n step 1032. In association with the SD-RSRP or SL-RSRP criterion, the RRC message in step 1043 or the SIB message in step 1044 may include information associated with at least one of sl-FilterCoefficientRSRP, sl-RSRP-Thresh, and sl-HystMin so as to identify the received discovery message as an object for response in step 1033 when a value obtained in consideration of an SD-RSRP or SL-RSRP measurement result, obtained by applying layer-3 filtering by using sl-FilterCoefficientRSRP in association with the U2U relay UE 820, together with hysteresis is above a threshold. The information may be the same as the configuration described with reference to FIGS. 7 or 8 or the configuration associated with the U2U relay UE 820 of FIG. 9, or may be configured differently for each UE, each cell, or each resource pool by using different parameters.

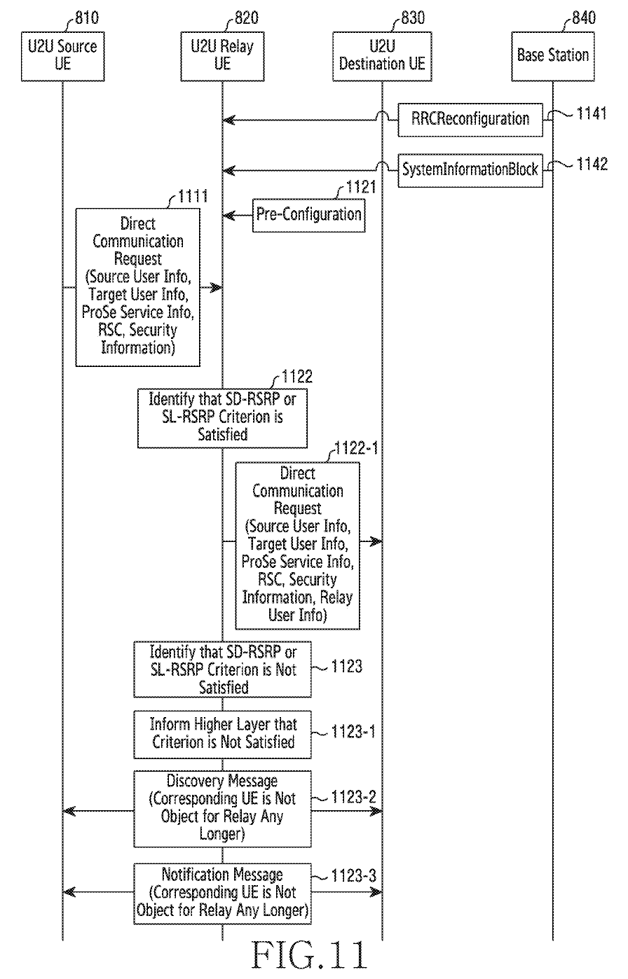

FIG. 11 illustrates an example in which a U2U source UE configures a PC5 unicast link with a U2U destination UE via a U2U relay UE by using a direct communication request message in a U2U relay according to an embodiment.

Referring to FIG. 11, in step 1111, the U2U source UE 810 may collectively produce a DCR message for configuring a discovery procedure and a PC5 unicast link. The DCR message may include one or more pieces of information among source user info, target user info, ProSe service Info, RSC, or security information. When the U2U source UE 810 is aware of information associated with the U2U destination UE 830 in advance, the U2U source UE 810 may further include target user info in the DCR message and transmit the same. When the U2U source UE 810 is not aware of information associated with the U2U destination UE 830 in advance, the U2U source UE 810 may transmit the DCR message excluding target user info.

In step 1122, the U2U relay UE 820 may use an SD-RSRP or SL-RSRP measurement result associated with the U2U source UE 810 in order to identify the DCR message transmitted by the U2U source UE 810 as an object for relay. An SD-RSRP or SL-RSRP criterion may be configured for the U2U relay UE 820 via an RRC message in step 1141 or an SIB message in step 1142 transmitted by the base station 840, or may be configured for the U2U relay UE 820 via a pre-configuration in step 1121. In association with the SD-RSRP or SL-RSRP criterion, the RRC message in step 1141 or the SIB message in step 1142 may include information associated with at least one of sl-FilterCoefficientRSRP, sl-RSRP-Thresh, and sl-HystMin so as to identify the received discovery message as an object for relay in step 1122 when a value obtained in consideration of an SD-RSRP or SL-RSRP measurement result, obtained by applying layer-3 filtering by using sl-FilterCoefficientRSRP in association with the U2U source UE 810, together with hysteresis is above a threshold. The information may be the same as the configuration described with reference to FIGS. 7 or 8, or may be configured differently for each UE, each cell, or each resource pool by using different parameters.

In step 1122, the U2U relay UE 820 identifies that the DCR message transmitted by the U2U source UE 810 as an object for relay., In step 1122-1, the U2U relay UE 820 may include information obtained from the DCR message transmitted by the U2U source UE 810 in a DCR message transmitted by the U2U relay UE 820. The DCR message may include one or more pieces of information among source user info, target user info, ProSe service Info, RSC, security information, and relay user info.

In step 1123, the U2U relay UE 820 identifies, by using at least one value of sl-RSRP-Thresh or sl-HystMin, that an SD-RSRP or SL-RSRP criterion of the DCR message transmitted by the U2U source UE 810 is not satisfied. In step 1123-2, the U2U relay UE 820 may identify that the corresponding DCR message is not an object for relay any longer, and may report the same to a higher layer in step 1123-1 so that information related thereto is not to be included. In addition, information indicating that the SD-RSRP or SL-RSRP of the U2U source UE 810 does not satisfy a criterion for an object for relay may be included in a discovery message in step 1123-2 or a notification message in step 1123-3 of a different type, and the information may be reported to neighboring UEs.

When the U2U destination UE 830 is requested to configure a U2U relay with the U2U source UE 810 via the DCR message transmitted by the U2U relay UE 820 in step 1122-1, determines to provide a service to the U2U source UE 810 via a U2U relay, and selects the U2U relay UE 820 according to the same configuration and procedure as the configuration performed in FIG. 8. The U2U destination UE 830 may respond to the DCR message of the U2U relay UE 820 and may start a PC5 unicast link configuration procedure. The U2U relay UE 820 may start a procedure of configuring a PC5 unicast link with the U2U source UE 810 so that the U2U destination UE 830 provides a U2U service via a U2U relay with the U2U source UE 810.

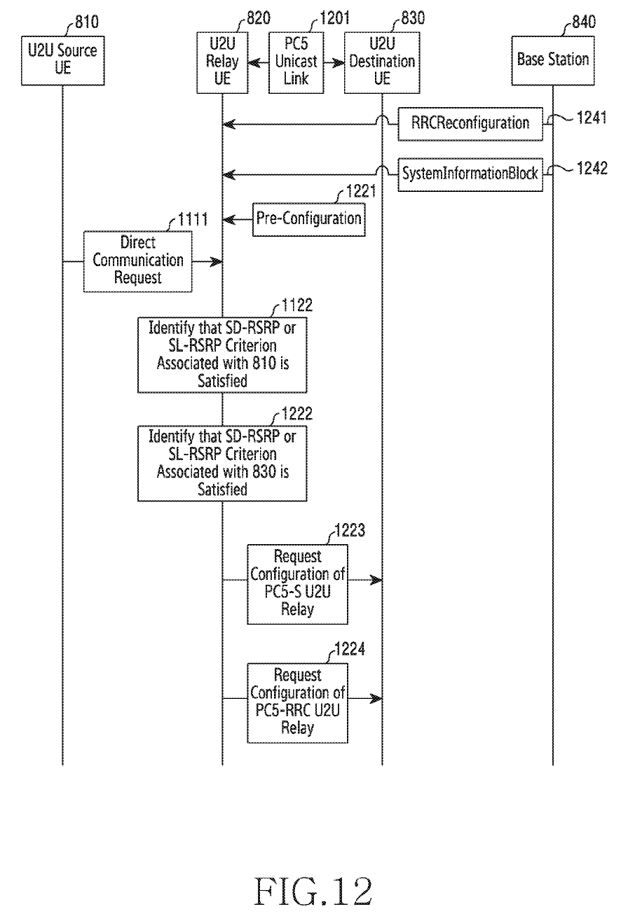

FIG. 12 illustrates a transmission of a DCR by a U2U relay UE in a U2U relay according to an embodiment.

A U2U source UE may transmit a collective DCR message that has been described with reference to FIG. 11, and may configure a PC5 unicast link and a U2U relay connection with a U2U destination UE. The U2U relay UE may identify a DCR message transmitted by the U2U source UE as an object for relay by using an SD-RSRP or SL-RSRP criterion, and when the DCR message is identified as an object for relay, the U2U relay UE may transmit the DCR message.

Referring to FIG. 12, in step 1111, the U2U relay UE 820 receives the DCR message for configuring a U2U relay with the U2U destination UE 830 from the U2U source UE 810. In step 1122, the U2U relay UE 820 identifies that the message as an object for relay and may already have a PC5 unicast link 1201 with the U2U destination UE 830. In this instance, in step 1223, the U2U relay UE 820 may transmit U2U relay configuration request information of the U2U source UE 810 to the U2U destination UE 830 via a PC5-S message. In step 1224, the U2U relay UE 820 transmits the configuration request in a PC5-RRC message 1224, based on to the procedure of FIG. 11.

The U2U relay UE 820 may use an SD-RSRP or SL-RSRP measurement result associated with the U2U destination UE 830 in order to identify whether to transmit the U2U relay configuration request information of the U2U source UE 810 to the U2U destination UE 830 in step 1222. An SD-RSRP or SL-RSRP criterion may be configured for the U2U relay UE 820 via an RRC message in step 1241 or an SIB message in step 1242 transmitted by the base station 840, or may be configured for the U2U relay UE 820 via a pre-configuration in step 1221. In association with the SD-RSRP or SL-RSRP criterion, the RRC message in step 1241 or the SIB message in step 1242 may include information associated with at least one of sl-FilterCoefficientRSRP, sl-RSRP-Thresh, and sl-HystMin so as to identify whether to transmit the relay configuration request information to the U2U destination UE 830 in step 1223 or step 1224 when a value obtained in consideration of an SD-RSRP or SL-RSRP measurement result, obtained by applying layer-3 filtering by using sl-FilterCoefficientRSRP in association with the U2U destination UE 830, together with hysteresis is above a threshold. The information may be the same as the configuration described with reference to FIGS. 7 or 8, or may be configured differently for each UE, each cell, or each resource pool by using different parameters.

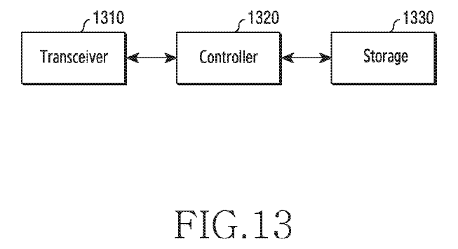

FIG. 13 illustrates the structure of a base station according to an embodiment.

Referring to FIG. 13, the base station may include a transceiver 1310, a controller 1320, and a storage unit 1330. The transceiver 1310, the controller 1320, and the storage unit 1330 may operate according to the communication method of the base station described above. A network device may also correspond to the structure of a base station. However, components of the base station are not limited to the above-described examples. For example, a base station may include more or fewer components than those described above, such as by including the transceiver 1310 and the controller 1320. In addition, the transceiver 1310, the controller 1320, and the storage unit 1330 may be implemented in a single chip form.

The transceiver 1310 collectively refers to a receiver of a base station and a transmitter of a base station, and may transmit and receive signals with a terminal, other base stations, or other network devices. The signal to be transmitted and received may include control information and data. For example, the transceiver 1310 may transmit system information to the terminal and may transmit a synchronization signal or a reference signal. To this end, the transceiver 1310 may include an RF transmitter that up-converts and amplifies the frequency of a transmitted signal, and an RF receiver that amplifies a received signal with low noise and down-converts its frequency. However, components of the transceiver 1310 are not limited to the RF transmitter and the RF receiver. The transceiver 1310 may include a wired/wireless transceiver, and may include various configurations for transmitting and receiving signals. In addition, the transceiver 1310 may receive a signal through a communication channel (e.g., a wireless channel), output the signal to the controller 1320, and transmit the signal output from the controller 1320 through the communication channel. In addition, the transceiver 1310 may receive and output a communication signal to a processor, and transmit the signal output from the processor to a terminal, another base station, or another entity through a wired or wireless network.

The storage unit 1330 may store programs and data necessary for the operation of the base station. In addition, the storage unit 1330 may store control information or data included in a signal obtained from a base station. The storage unit 1330 may include a storage medium, such as a read only memory (ROM), a random access memory (RAM), a hard disk, a compact disc (CD)-ROM, and a digital versatile disc (DVD), or a combination of storage media. In addition, the storage unit 1330 may store at least one of information transmitted and received through the transceiver 1310 and information generated through the controller 1320.

Herein, the controller 1320 may be defined as a circuit or an application-specific integrated circuit or at least one processor. The processor may include a communication processor (CP) for controlling communication and an application processor (AP) for controlling upper layers, such as application programs. The controller 1320 may control the overall operation of the base station according to the embodiment proposed in the disclosure. For example, the controller 1320 may control signal flow between blocks to perform an operation according to the flowchart described above.

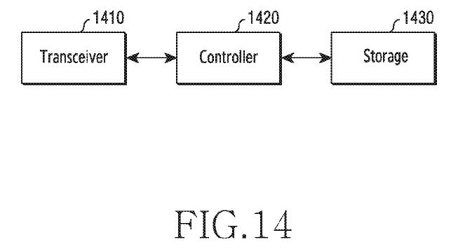

FIG. 14 illustrates a structure of a terminal according to an embodiment.

Referring to FIG. 14, a terminal may include a transceiver 1410, a controller 1420, and a storage unit 1430. The transceiver unit 1410, the controller 1420, and the storage unit 1430 may operate according to the communication method of the terminal described above. However, the components of the terminal are not limited to the above-described examples. For example, a terminal may include more or fewer components than the aforementioned components, such as by including the transceiver 1410 and the controller 1420. The transceiver 1410, the controller 1420, and the storage unit 1430 may be implemented as a single chip.

The transceiver unit 1410 collectively refers to a reception unit of a terminal and a transmission unit of a terminal, and may transmit/receive signals to and from a base station, other terminals, or network entities. A signal transmitted and received with the base station may include control information and data. For example, the transceiver 1410 may receive system information from a base station and may receive a synchronization signal or a reference signal. To this end, the transceiver 1410 may include an RF transmitter that up-converts and amplifies the frequency of a transmitted signal, and an RF receiver that amplifies a received signal with low noise and down-converts its frequency. However, components of the transceiver 1410 are not limited to the RF transmitter and the RF receiver. In addition, the transceiver 1410 may include a wired/wireless transceiver, and may include various components for transmitting and receiving signals. In addition, the transceiver 1410 may receive a signal through a wireless channel, output the signal to the controller 1420, and transmit the signal output from the controller 1420 through a wireless channel. In addition, the transceiver 710 may receive and output a communication signal to a processor, and transmit the signal output from the processor to a network entity through a wired or wireless network.

The storage unit 1430 may store programs and data required for operation of the terminal. In addition, the storage unit 1430 may store control information or data included in a signal obtained from the terminal. The storage unit 1430 may include a storage medium, such as a ROM, a RAM, a hard disk, a CD-ROM, and a DVD, or a combination of storage media.

Herein, the controller 1420 may be defined as a circuit or an application-specific integrated circuit or at least one processor. The processor may include a communication processor (CP) for controlling communication and an application processor (AP) for controlling upper layers, such as application programs. The controller 1420 may control overall steps of a terminal according to an embodiment proposed in the disclosure. For example, the controller 1420 may control a signal flow between blocks to perform an operation according to the flowchart described above.

Methods according to the embodiments of the disclosure may be implemented in the form of hardware, software, or a combination of hardware and software.

When implemented in software, a computer readable storage medium storing one or more programs (software modules) may be provided. One or more programs stored in a computer-readable storage medium are configured for execution by one or more processors in an electronic device. One or more programs include instructions that cause the electronic device to execute methods according to embodiments described in the disclosure.

Such programs (software modules, software) may include a random access memory, a non-volatile memory including a flash memory, a ROM, and an electrically erasable programmable ROM (EEPROM), magnetic disc storage device, a compact disc-ROM (CD-ROM), DVDs, or other forms of It can be stored on optical storage devices, magnetic cassettes. Alternatively, it may be stored in a memory composed of a combination of some or all of these. In addition, each configuration memory may be included in multiple numbers.

In addition, the program may be performed through a communication network, such as the Internet, an Intranet, a local area network (LAN), a wide LAN (WLAN), or a storage area network (SAN), or a communication network composed of a combination thereof. It can be stored on an attachable storage device that can be accessed. Such a storage device may be connected to a device performing an embodiment of the disclosure through an external port. In addition, a separate storage device on a communication network may be connected to a device performing an embodiment of the disclosure.

Each block of the process flow chart diagrams and combinations of the flow chart diagrams can be performed by computer program instructions. These computer program instructions may be embodied in a processor of a general purpose computer, special purpose computer, or other programmable data processing equipment, so that the instructions executed by the processor of the computer or other programmable data processing equipment are described in the flowchart block(s) and create a means to perform functions. These computer program instructions may also be stored in a computer usable or computer readable memory that can be directed to a computer or other programmable data processing equipment to implement functionality in a particular way, such that the computer usable or computer readable memory The instructions stored in are also capable of producing an article of manufacture containing instruction means that perform the functions described in the flowchart block(s). The computer program instructions can also be loaded on a computer or other programmable data processing equipment, so that a series of operational steps are performed on the computer or other programmable data processing equipment to create a computer-executed process to generate computer or other programmable data processing equipment. Instructions for performing processing equipment may also provide steps for performing the functions described in the flowchart block(s).

Additionally, each block may represent a module, segment, or portion of code that includes one or more executable instructions for executing specified logical function(s). It should also be noted that in some alternative implementations it is possible for the functions mentioned in the blocks to occur out of order. For example, it is possible that two blocks shown in succession may in fact be performed substantially concurrently, or that the blocks may sometimes be performed in reverse order depending on their function.

While the disclosure has been shown and described with reference to various embodiments thereof, it will be understood by those skilled in the art that various changes in form and details may be made therein without departing from the spirit and scope of the of the disclosure as defined by the appended claims and their equivalents.

What is claimed is:

1. A method performed by a relay user equipment (UE) for a sidelink UE-to-UE (U2U) relay in a wireless communication system, the method comprising:
obtaining first configuration information for the relay UE including information on a first reference signal received power (RSRP) threshold for the relay UE;
determining, based on the information on the first RSRP threshold, whether to forward a first discovery message received from a source remote UE; and
transmitting, to a target remote UE, the first discovery message based on the determination,
wherein the first discovery message includes a direct communication request (DCR) message.

2. The method of claim 1,
wherein the first discovery message is forwarded to the target remote UE in case that an RSRP of the first discovery message received from the source remote UE is greater than the first RSRP threshold.

3. The method of claim 1, further comprising:
receiving a second discovery message corresponding to the first discovery message, based on second configuration information for the target remote UE including information on a second RSRP threshold.

4. The method of claim 3,
wherein, in case that an RSRP of the relay UE is greater than the second RSRP threshold, the relay UE is selected for the target remote UE.

5. The method of claim 3,
wherein the first RSRP threshold is for at least one of sidelink discovery-reference signal received power (SD-RSRP) or sidelink (SL)-RSRP, and
wherein the second RSRP threshold is for the SD-RSRP.

6. The method of claim 1,
wherein, in case that a PC5 link exists between the relay UE and the target remote UE, the DCR message is forwarded by the PC5 link.

7. The method of claim 1,
wherein the first configuration information is pre-configured or is included in a system information block (SIB) or a radio resource control (RRC) message.

8. A relay user equipment (UE) for a sidelink UE-to-UE (U2U) relay, comprising:
at least one transceiver;
at least one processor communicatively coupled to the at least one transceiver; and
at least one memory, communicatively coupled to the at least one processor, storing instructions executable by the at least one processor individually or in any combination to cause the relay UE to:
obtain first configuration information for the relay UE including information on a first reference signal received power (RSRP) threshold for the relay UE,
determine, based on the information on the first RSRP threshold, whether to forward a first discovery message received from a source remote UE, and
transmit, to a target remote UE, the first discovery message based on the determination,
wherein the first discovery message includes a direct communication request (DCR) message.

9. The relay UE of claim 8,
wherein the first discovery message is forwarded to the target remote UE in case that an RSRP of the first discovery message received from the source remote UE is greater than the first RSRP threshold.

10. The relay UE of claim 8, wherein the instructions further cause the relay UE to:
receive a second discovery message corresponding to the first discovery message, based on second configuration information for the target remote UE including information on a second RSRP threshold.

11. The relay UE of claim 10,
wherein, in case that an RSRP of the relay UE is greater than the second RSRP threshold, the relay UE is selected for the target remote UE.

12. The relay UE of claim 10,
wherein the first RSRP threshold is for at least one of sidelink discovery-reference signal received power (SD-RSRP) or sidelink (SL)-RSRP, and
wherein the second RSRP threshold is for the SD-RSRP.

13. The relay UE of claim 8,
wherein, in case that a PC5 link exists between the relay UE and the target remote UE, the DCR message is forwarded by the PC5 link.

14. The relay UE of claim 8,
wherein the first configuration information is pre-configured or is included in a system information block (SIB) or a radio resource control (RRC) message.
